(19) United States
(12) Patent Application Publication
(10) Pub. No.: US 2016/0078399 A1
(43) Pub. Date: Mar. 17, 2016

(54) TEMPORARY WAREHOUSE LOCATOR

(71) Applicants: Akshay Gadre, North Wales, PA (US); David DeMarco, Chester Springs, PA (US)

(72) Inventors: Akshay Gadre, North Wales, PA (US); David DeMarco, Chester Springs, PA (US)

(21) Appl. No.: 14/587,815

(22) Filed: Dec. 31, 2014

Related U.S. Application Data
(60) Provisional application No. 62/049,734, filed on Sep. 12, 2014.

(51) Int. Cl. G06Q 10/08; G06Q 30/06

(52) U.S. Cl. CPC G06Q 10/087; G06Q 30/0645

(57) ABSTRACT

A temporary warehouse environment includes various platforms for locating, establishing, and operating one or more temporary houses. A temporary warehouse locator identifies potential geographic locations for one or more temporary warehouses based on prior transactions conducted by a merchant and predicted transactions or operating expenditures. The identified geographic locations may then be leveraged by a temporary warehouse marketplace, which connects the merchant with owners and/or operators of available property in the identified geographic locations. A temporary warehouse recruiter further connects the merchant with potential employees for maintain and operating the temporary warehouse and includes various mechanisms by which the merchant may identify potential employees based on their prior employment history. Finally, a temporary warehouse system provides day-to-day operations for the temporary warehouse, including fulfilling orders placed by customers and monitoring the shipments of such orders.

### CROSS-REFERENCE TO RELATED APPLICATIONS

This application claims the benefit of priority to U.S. Pat. App. No. 62/049,734, titled “TEMPORARY WAREHOUSES” and filed Sep. 12, 2014, the disclosure of which is incorporated by reference herein in its entirety.

### TECHNICAL FIELD

The present application relates generally to the field of computer technology; and, in specific exemplary embodiments, to systems and methods for proprietors and retailers to setup and manage temporary warehouses, for example a temporary warehouse to accommodate a temporary spike in local demand.

### BACKGROUND

Presently, most retailers either fulfill orders from their warehouses or their stores. Therefore, the “ship-to” time and delivery cost are very important factors when it comes to determining a location for the warehouses and stores that a business may operate.

However, it is often the case that a retailer has a short-term need of warehouse facilities but cannot afford to invest in the complete warehouse infrastructure. This may present a new challenge to the retailer—find solutions that promise fast delivery but do not require high infrastructure investment or otherwise eat up the margins of the overall sales transaction.

### BRIEF DESCRIPTION OF DRAWINGS

Some embodiments of the present disclosure are illustrated by way of example and not limitation in the figures of the accompanying drawings, in which like reference numbers indicate similar elements, and in which: Some embodiments of the present disclosure are illustrated by way of example and not limitation in the figures of the accompanying drawings, in which like reference numbers indicate similar elements, and in which:

FIG. 1 illustrates an architecture diagram of a temporary warehouse environment, according to an example embodiment, in which various platforms are in communication via one or more networks.

FIG. 2 illustrates a block diagram of a temporary warehouse locator according to an example embodiment.

FIG. 3 illustrates a block diagram of a temporary warehouse marketplace according to an example embodiment.

FIG. 4 illustrates a block diagram of a temporary warehouse recruiter according to an example embodiment

FIG. 5 is a network diagram depicting a network system having a client-server architecture configured for exchanging data over a network, according to one embodiment.

FIG. 6 shows a block diagram illustrating one example embodiment of a merchant marketplace application.

FIG. 7 shows a block diagram illustrating one example embodiment of a temporary warehouse application.

FIG. 8 shows a flow diagram illustrating one example embodiment of a method for identifying geographic locations for a temporary warehouse.

FIG. 9 shows a flow diagram illustrating one example embodiment of a method for connecting a merchant with a need for a property to host a temporary warehouse with an owner/operator of such a property.

FIG. 10 shows a flow diagram illustrating one example embodiment of a method for connecting a merchant with a need for a workforce to operate a temporary warehouse with potential employees.

FIG. 11 shows a flow diagram illustrating one example embodiment of an operation of a temporary warehouse application.

FIG. 12 shows a flow diagram illustrating one example embodiment of a method for operating a temporary warehouse.

FIG. 13 shows a diagrammatic representation of machine, in the example form of a computer system, within which a set of instructions may be executed to cause the machine to perform any one or more of the methodologies discussed herein.

### DETAILED DESCRIPTION

Retailers look for different ways and means to source their orders and send their products to their customers at the cheapest price and in the quickest possible time frame. Warehouse shipping or ship-from-store are typically the options available for sourcing an order where customer store pick-up is not an option. In these cases, shipping costs may eat up a lot of the margins on an order and become prohibitive for smaller retailers.

Very large retailers may have expensive infrastructures and may be able to afford, for example, two-day ship options at acceptable prices from any of their inventory locations. However, since order volume typically goes up and down, depending on the season, geography, and/or customer demand, even seasonal ramp-up in existing warehouses takes time/effort and high costs. Furthermore, setting up new stores or new warehouses to mitigate shipping costs may also be expensive.

In an example embodiment, this disclosure provides for a temporary warehouse locator configured to identify potential geographic locations for a retailer to establish a temporary warehouse. The temporary warehouse locator leverages different types of information, such as previous transactions conducted by the retailer and the locations for one or more of the retailer's storefronts, to identify these geographic locations. The temporary warehouse locator further leverages operating costs of similar situated businesses in the identified geographic locations to assist in identifying potential geographic locations where the retailer should establish a temporary warehouse.

Accordingly, in one embodiment, this disclosure describes a method that includes receiving, with one or more processors, a request to identify one or more geographic locations for a temporary warehouse, obtaining, with the one or more processors, transaction information associated with a plurality of transactions conducted by an organization, and determining the one or more geographic locations for the temporary warehouse based on the obtained transaction information and the obtained shipping information. The method also includes displaying a first display that includes the determined one or more geographic locations for the temporary warehouse, the first display indicating a degree of desirability for at least one of the one or more geographic locations, and displaying a second display with the first display, the second display indicating operational information for the temporary warehouse for the at least one of the determined one or more geographic locations.

In another embodiment of the method, the method further includes applying a mapping to the obtained transaction information, the mapping translating a first plurality of data fields of the transaction information to a second plurality of data fields, where at least one of the second plurality of data fields is used in determining the one or more geographic locations for the temporary warehouse.

In a further embodiment of the method, determining the one or more geographic locations for the temporary warehouse is further based on a plurality of geographic locations where the organization has a preexisting presence.

In yet another embodiment of the method, the method includes after displaying the first display, receiving a change to the transaction information, and updating the first display to indicate a change in the degree of desirability for the at least one of the one or more geographic locations.

In yet a further embodiment of the method, the operational information for the temporary warehouse is based on an operating cost associated with the at least one of the determined one or more geographic locations.

In another embodiment of the method, the method includes receiving an acceptable operating cost for operating the temporary warehouse, and updating the second display to show a change in the operational information based on the received acceptable operating cost.

In a further embodiment of the method, the transaction information is represented as a plurality of constraints, and determining the one or more geographic locations for the temporary warehouse is performed through constraint-based linear optimization with the plurality of constraints.

This disclosure also describes a system that includes a non-transitory, computer-readable medium storing computer-executable instructions, and one or more processors in communication with the non-transitory, computer-readable medium that, having executed the computer-executable instructions, are configured to receive a request to identify one or more geographic locations for a temporary warehouse, obtain transaction information associated with a plurality of transactions conducted by an organization, and determine the one or more geographic locations for the temporary warehouse based on the obtained transaction information and the obtained shipping information. The one or more processors are also further configured to display a first display that includes the determined one or more geographic locations for the temporary warehouse, the first display indicating a degree of desirability for at least one of the one or more geographic locations, and display a second display with the first display, the second display indicating operational information for the temporary warehouse for the at least one of the determined one or more geographic locations.

In another embodiment of the system, the one or more processors are further configured to apply a mapping to the obtained transaction information, the mapping translating a first plurality of data fields of the transaction information to a second plurality of data fields, where at least one of the second plurality of data fields is used in determining the one or more geographic locations for the temporary warehouse.

In a further embodiment of the system, the one or more processors are further configured to determine the one or more geographic locations for the temporary warehouse based on a plurality of geographic locations where the organization has a preexisting presence.

In yet another embodiment of the system, the one or more processors are further configured to receive a change to the transaction information after displaying the first display, and update the first display to indicate a change in the degree of desirability for the at least one of the one or more geographic locations.

In yet a further embodiment of the system, the operational information for the temporary warehouse is based on an operating cost associated with the at least one of the determined one or more geographic locations.

In another embodiment of the system, the one or more processors are further configured to receive an acceptable operating cost for operating the temporary warehouse, and update the second display to show a change in the operational information based on the received acceptable operating cost.

In a further embodiment of the system, the transaction information is represented as a plurality of constraints, and the one or more processors are further configured to determine the one or more geographic locations for the temporary warehouse through constraint-based linear optimization with the plurality of constraints.

This disclosure further provides for a non-transitory, computer-readable medium storing computer-executable instructions thereon that, when executed by one or more processors, cause the one or more processors to perform a method, the method comprising receiving, with one or more processors, a request to identify one or more geographic locations for a temporary warehouse, obtaining, with the one or more processors, transaction information associated with a plurality of transactions conducted by an organization, and determining the one or more geographic locations for the temporary warehouse based on the obtained transaction information and the obtained shipping information. The method further includes displaying a first display that includes the determined one or more geographic locations for the temporary warehouse, the first display indicating a degree of desirability for at least one of the one or more geographic locations, and displaying a second display with the first display, the second display indicating operational information for the temporary warehouse for the at least one of the determined one or more geographic locations.

In another embodiment of the non-transitory, computer-readable medium, the method further comprises applying a mapping to the obtained transaction information, the mapping translating a first plurality of data fields of the transaction information to a second plurality of data fields, where at least one of the second plurality of data fields is used in determining the one or more geographic locations for the temporary warehouse.

In a further embodiment of the non-transitory, computer-readable medium, determining the one or more geographic locations for the temporary warehouse is further based on a plurality of geographic locations where the organization has a preexisting presence.

In yet another embodiment of the non-transitory, computer-readable medium, the method further comprises receiving a change to the transaction information after displaying the first display, and updating the first display to indicate a change in the degree of desirability for the at least one of the one or more geographic locations.

In yet a further embodiment of the non-transitory, computer-readable medium, the operational information for the temporary warehouse is based on an operating cost associated with the at least one of the determined one or more geographic locations.

In another embodiment of the non-transitory, computer-readable medium, the method further comprises receiving an acceptable operating cost for operating the temporary warehouse, and updating the second display to show a change in the operational information based on the received acceptable operating cost.

After potential geographic locations are identified, the retailer may then desire to seek out an owner or operator of a property capable of handling the retailer's inventory. Accordingly, this disclosure also provides for a temporary warehouse marketplace where a retailer looking to establish a temporary warehouse can list its needs (e.g., amount of space, type of industry, distance from a geographic location, etc.) and have various owners or operators of properties bid on the listing. Once a winning bid has been identified, the retailer may then engage in a leasing and/or sub-leasing transaction with the owner or operator of the winning bid via an electronic document exchange established by the temporary warehouse marketplace. Furthermore, the temporary warehouse marketplace provides a portal to other actions that the retailer with respect to the property designated as the temporary warehouse, such as order inventory, track shipments to and/or from the temporary warehouse, and manage the available space within the temporary warehouse. Accordingly, in one embodiment, this disclosure describes a method that includes receiving, by one or more processors, a listing from a first entity for a desired building type within a predetermined distance of a geographic location, the listing identifying at least one characteristic to be satisfied for the desired building type and a fee to be paid upon a successful bid for the listing, and receiving, by the one or more processors, and from a plurality of entities, a plurality of offers responsive to the listing, each offer being associated with a building of the desired building type at or within the predetermined distance. The method also includes adjusting, by the one or more processors, the fee to be paid based on the received plurality of offers, receiving, by the one or more processors, a selection of at least one offer of the plurality of offers, and facilitating, by the one or more processors, a transaction between the first entity and a second entity associated with the selected at least one offer, the transaction comprising an agreement for the business to use the building associated with the selected at least one offer.

In another embodiment of the method, the listing includes an acceptance price, the acceptance price indicating a price the first entity is willing to accept to terminate the listing and proceed with a transaction between the first entity and the second entity based on the listing.

In a further embodiment of the method, the method includes exchanging a plurality of electronic documents in completing the transaction between the first entity and the second entity, wherein at least one electronic document of the plurality of electronic documents is signed by at least one of the first entity or the second entity.

In yet another embodiment of the method, the at least one building characteristic identifies a preferred size of the desired building type,

In yet a further embodiment of the method, adjusting the fee comprises increasing the fee by a predetermined amount based on a predetermined number of offers being received for the listing.

In another embodiment of the method, the geographic location was determined from operational costs associated with one or more businesses at or within the predetermined distance to the geographic location.

In a further embodiment of the method, the geographic location was determined from prior transaction information for the business associated with the listing.

This disclosure also provides for a system that includes a non-transitory, computer-readable medium storing computer-executable instructions, and one or more processors in communication with the non-transitory, computer-readable medium that, having executed the computer-executable instructions, are configured to receive a listing from a first entity for a desired building type within a predetermined distance of a geographic location, the listing identifying at least one characteristic to be satisfied for the desired building type and a fee to be paid upon a successful bid for the listing. The one or more processors are also configured to receive, from a plurality of entities, a plurality of offers responsive to the listing, each offer being associated with a building of the desired building type at or within the predetermined distance, adjust the fee to be paid based on the received plurality of offers, receive, a selection of at least one offer of the plurality of offers, and facilitate a transaction between the first entity and a second entity associated with the selected at least one offer, the transaction comprising an agreement for the business to use the building associated with the selected at least one offer.

In another embodiment of the system, the listing includes an acceptance price, the acceptance price indicating a price the first entity is willing to accept to terminate the listing and proceed with a transaction between the first entity and the second entity based on the listing.

In a further embodiment of the system, the one or more processors are further configured to exchange a plurality of electronic documents in completing the transaction between the first entity and the second entity, wherein at least one electronic document of the plurality of electronic documents is signed by at least one of the first entity or the second entity.

In yet another embodiment of the system, the at least one building characteristic identifies a preferred size of the desired building type.

In yet a further embodiment of the system, the one or more processors are configured to adjust the fee by increasing the fee by a predetermined amount based on a predetermined number of offers being received for the listing.

In another embodiment of the system, the geographic location was determined from operational costs associated with one or more businesses at or within the predetermined distance to the geographic location.

In a further embodiment of the system, the geographic location was determined from prior transaction information for a business associated with the listing.

In addition, this disclosure describes a non-transitory, computer-readable medium having computer-executable instructions stored thereon that, when executed by one or more processors, cause the one or more processors to perform a method, the method including receiving, by one or more processors, a listing from a first entity for a desired building type within a predetermined distance of a geographic location, the listing identifying at least one characteristic to be satisfied for the desired building type and a fee to be paid upon a successful bid for the listing and receiving, by the one or more processors, and from a plurality of entities, a plurality of offers responsive to the listing, each offer being associated with a building of the desired building type at or within the predetermined distance. The method also includes adjusting, by the one or more processors, the fee to be paid based on the received plurality of offers, receiving, by the one or more processors, a selection of at least one offer of the plurality of offers, and facilitating, by the one or more processors, a transaction between the first entity and a second entity associated with the selected at least one offer, the transaction comprising an agreement for the business to use the building associated with the selected at least one offer.

In another embodiment of the non-transitory, computer-readable medium, the listing includes an acceptance price, the acceptance price indicating a price the first entity is willing to accept to terminate receiving offers for the listing and to proceed with a transaction between the first entity and the second entity based on the listing.

In a further embodiment of the non-transitory, computer-readable medium, the method further comprises exchanging a plurality of electronic documents in completing the transaction between the first entity and the second entity, wherein at least one electronic document of the plurality of electronic documents is signed by at least one of the first entity or the second entity.

In yet another embodiment of the non-transitory, computer-readable medium, the at least one building characteristic identifies a preferred size of the desired building type.

In yet a further embodiment of the non-transitory, computer-readable medium, adjusting the fee comprises increasing the fee by a predetermined amount based on a predetermined number of offers being received for the listing.

In another embodiment of the non-transitory, computer-readable medium, the geographic location was determined from operational costs associated with one or more businesses at or within the predetermined distance to the geographic location.

As the retailer may need a workforce to operate the temporary warehouse, this disclosure also provides a temporary warehouse recruiter, where retailers or an agent acting on behalf of the retailer can list various employment opportunities for one or more temporary warehouses. People looking to be employed in such opportunities can then bid on listings, where the person of the winning bid enters into an employment contract with the retailer or agent. The temporary warehouse recruiter may allow people to sign up for recruiter accounts, where the accounts are associated with a rating and/or feedback system such that employers can rate or leave feedback regarding a particular employee. In this way, when a retailer or agent receives bids for a particular listing, the retailer or agent can review the rating and/or prior feedback for a given bid to determine whether the person associated with the given bid would be a desirable employee.

Accordingly, in one embodiment, this disclosure provides a method that includes receiving, by one or more processors, a listing from a first entity for an employment position, the listing identifying at least one characteristic to be satisfied for the employment position, and receiving, by the one or more processors, from a plurality of entities, a first plurality of offers responsive to the listing, each offer being associated with a person and identifying a plurality of employment characteristics associated with the person. The method also includes determining, by the one or more processors, a second plurality of offers from the first plurality of offers, wherein at least one of the second plurality of offers is associated with at least one employment characteristic that satisfies the at least one characteristic of the listing, receiving, by the one or more processors, a selection of the at least one offer of the second plurality of offers, and facilitating, by the one or more processors, a transaction between the first entity and a second entity associated with the selected at least one offer, the transaction comprising an agreement for the person associated with the selected at least one offer to be hired for the employment position.

In another embodiment of the method, the listing includes an acceptance salary, the acceptance salary indicating a salary a person to be hired for the employment position is willing to accept for the first entity to terminate receiving offers for the listing and hire the person for the employment position.

In a further embodiment of the method, the method includes exchanging a plurality of electronic documents in completing the transaction between the first entity and the second entity, wherein at least one electronic document of the plurality of electronic documents is signed by at least one of the first entity or the second entity.

In yet another embodiment of the method, a person associated with at least one of the first plurality of offers is associated with a user profile, the user profile comprising an employment rating indicating past performance by the person in at least one other employment position.

In yet a further embodiment of the method, determining the second plurality of offers from the first plurality of offers comprises determining the at least one of the second plurality of offers based on the employment rating associated with the person associated with the at least one of the second plurality of offers.

In another embodiment of the method, the listing comprises a minimum employment rating for an offer of the first plurality of offers to be selected for the second plurality of offers.

In a further embodiment of the method, the at least one characteristic associated with the listing is a predetermined distance threshold to a geographic location, and determining the second plurality of offers comprises identifying the second plurality of offers based on the predetermined distance threshold.

This disclosure further provides for a system that includes a non-transitory, computer-readable medium storing computer-executable instructions, and one or more processors in communication with the non-transitory, computer-readable medium that, having executed the computer-executable instructions, are configured to receive a listing from a first entity for an employment position, the listing identifying at least one characteristic to be satisfied for the employment position, and receive, from a plurality of entities, a first plurality of offers responsive to the listing, each offer being associated with a person and identifying a plurality of employment characteristics associated with the person. The one or more processors are also configured to determine a second plurality of offers from the first plurality of offers, wherein at least one of the second plurality of offers is associated with at least one employment characteristic that satisfies the at least one characteristic of the listing, receive a selection of the at least one offer of the second plurality of offers, and facilitate a transaction between the first entity and a second entity associated with the selected at least one offer, the transaction comprising an agreement for the person associated with the selected at least one offer to be hired for the employment position.

In another embodiment of the system, the listing includes an acceptance salary, the acceptance salary indicating a salary a person to be hired for the employment position is willing to accept for the first entity to terminate receiving offers for the listing and hire the person for the employment position.

In a further embodiment of the system, the one or more processors are further configured to exchange a plurality of electronic documents in completing the transaction between the first entity and the second entity, wherein at least one electronic document of the plurality of electronic documents is signed by at least one of the first entity or the second entity.

In yet another embodiment of the system, a person associated with at least one of the first plurality of offers is associated with a user profile, the user profile comprising an employment rating indicating past performance by the person in at least one other employment position.

In yet a further embodiment of the system, the one or more processors are further configured to determine the second plurality of offers from the first plurality of offers by determining the at least one of the second plurality of offers based on the employment rating associated with the person associated with the at least one of the second plurality of offers.

In another embodiment of the system, the listing comprises a minimum employment rating for an offer of the first plurality of offers to be selected for the second plurality of offers.

In a further embodiment of the system, the at least one characteristic associated with the listing is a predetermined distance threshold to a geographic location, and the one or more processors are further configured to determine the second plurality of offers by identifying the second plurality of offers based on the predetermined distance threshold.

This disclosure further describes a non-transitory, computer-readable medium storing computer-executable instructions that, when executed by one or more processors, cause the one or more processors to perform a method, the method including receiving a listing from a first entity for an employment position, the listing identifying at least one characteristic to be satisfied for the employment position, and receiving, from a plurality of entities, a first plurality of offers responsive to the listing, each offer being associated with a person and identifying a plurality of employment characteristics associated with the person. The method further includes determining a second plurality of offers from the first plurality of offers, wherein at least one of the second plurality of offers is associated with at least one employment characteristic that satisfies the at least one characteristic of the listing, receiving a selection of the at least one offer of the second plurality of offers, and facilitating a transaction between the first entity and a second entity associated with the selected at least one offer, the transaction comprising an agreement for the person associated with the selected at least one offer to be hired for the employment position.

In another embodiment of the non-transitory, computer-readable medium, the listing includes an acceptance salary, the acceptance salary indicating a salary a person to be hired for the employment position is willing to accept for the first entity to terminate receiving offers for the listing and hire the person for the employment position.

In a further embodiment of the non-transitory, computer-readable medium, the method further comprises exchanging a plurality of electronic documents in completing the transaction between the first entity and the second entity, wherein at least one electronic document of the plurality of electronic documents is signed by at least one of the first entity or the second entity.

In yet another embodiment of the non-transitory, computer-readable medium, a person associated with at least one of the first plurality of offers is associated with a user profile, the user profile comprising an employment rating indicating past performance by the person in at least one other employment position.

In yet a further embodiment of the non-transitory, computer-readable medium, determining the second plurality of offers from the first plurality of offers comprises determining the at least one of the second plurality of offers based on the employment rating associated with the person associated with the at least one of the second plurality of offers.

In another embodiment of the non-transitory, computer-readable medium, the listing comprises a minimum employment rating for an offer of the first plurality of offers to be selected for the second plurality of offers.

The following paragraphs describe operational examples of the systems and methods disclosed herein. In an example embodiment, an owner or operator of a property capable of handling a specified amount of inventory, e.g., a high school, may provide an amount of space, e.g., 2000 sq. ft. of its high school premises, for a specified amount of time, e.g., the summer time, to be rented for warehousing of retail goods. The locations of such “seasonal warehouse” proprietors may be convenient, at least during some period of time, to a retailer that does not otherwise have a presence in that area. The temporary warehouse may host, for example, hot selling summer items from various vendors.

In an example embodiment, a high school acting as a seasonal warehouse facility may be listed as a “Store” at a merchant's website when an online user proceeds to buy an item hosted at a seasonal warehouse facility. The user may then select the school as the pickup location for the purchased item. Upon purchase, the user may go to the local high school and pick-up the item.

In an example embodiment, owners or operators of temporary warehouses (e.g., school, small businesses, retail stores, malls etc.) may have their stocked inventory listed for sale by the respective retailers providing the inventory. For example, the inventory stocked at a temporary warehouse may be listed on respective electronic storefronts (e.g., at an electronic merchant marketplace) of the retailers stocking inventory at the temporary warehouse. The item listing may include descriptions of the item and any other details, such as price and available amount for review by potential customers.

In an example embodiment, once the user picks up a purchased item from a temporary warehouse, a mobile confirmation may automatically update the item quantity in an electronic merchant marketplace where a merchant (that stocks this item at the temporary warehouse) lists their inventory for sale. This may insure that orders are only accepted if sufficient inventory is available at the temporary warehouse. In an example, inventory may be replenished on a specified time schedule, e.g., a daily basis.

In an example embodiment, retailers may open and process temporary warehouses to fulfil orders as either a pick-up location or a ship-from store location.

In an example embodiment, a daily inventory feed from a retailer to an electronic merchant marketplace (e.g., web store) may include details of the products available at a temporary warehouse.

In an example embodiment, a retailer may ramp up a temporary warehouse by sending inventory to the location and getting delivery staff working at the warehouse.

In an example embodiment, a location configured as a temporary warehouse may show up when a customer is online and is making a purchase. Upon searching for pick-up locations for a purchased item, the customer may determine the temporary warehouse is nearest the pick-up location and therefore choose it for the pick-up location of the purchased item.

In an example embodiment, once a customer places an order at an electronic merchant marketplace, a temporary warehouse stocking the item may be notified of the purchase and, for example, receive an email/text notification regarding the details of the customer's order.

In an example embodiment, when user goes to the pick-up location, a purchased item may be picked/confirmed using a mobile pick/confirm operation that automatically decrements a web available inventory of the item. Notifications/feeds may be sent to the selling retailer after a transaction is complete, and may be sent via daily point of sale (POS) updates.

In an example embodiment, information regarding sales at the location is sent to the retail vendor and, based on the sales information, the retailer may determine that the presence of the retailer's selection of merchandise at the location was a cause of an increase in sales of other unrelated items at the location.

The description that follows includes illustrative systems, methods, techniques, instruction sequences, and computing machine program products that embody the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. Further, well-known instruction instances, protocols, structures and techniques have not been shown in detail.

As used herein, the term “or” may be construed in an inclusive or exclusive sense. Similarly, the term “exemplary” may be construed merely to mean an example of something or an exemplar and not necessarily a preferred means of accomplishing a goal. Additionally, although various exemplary embodiments discussed below focus on an existing enterprise in a business environment, the embodiments are merely given for clarity in disclosure. Thus, any type of enterprise system such as a governmental system (including schools, courthouses, and other judicially-related systems, etc.), religious, or any other non-business environment, is considered as being within the scope of the present invention.

Furthermore, while the below description may refer to an entity or organization as a “retailer,” the term “retailer” should be taken to mean any entity or organization providing goods and/or services, whether for sale or for charity. Thus, the term “retailer” should also be synonymous or interchangeable with such terms as “merchant,” “vendor,” “non-profit organization,” “business,” “dealer,” “trader,” and other similar terms. However, for simplicity and ease of reading, the below description employs the term “retailer” to convey this concept.

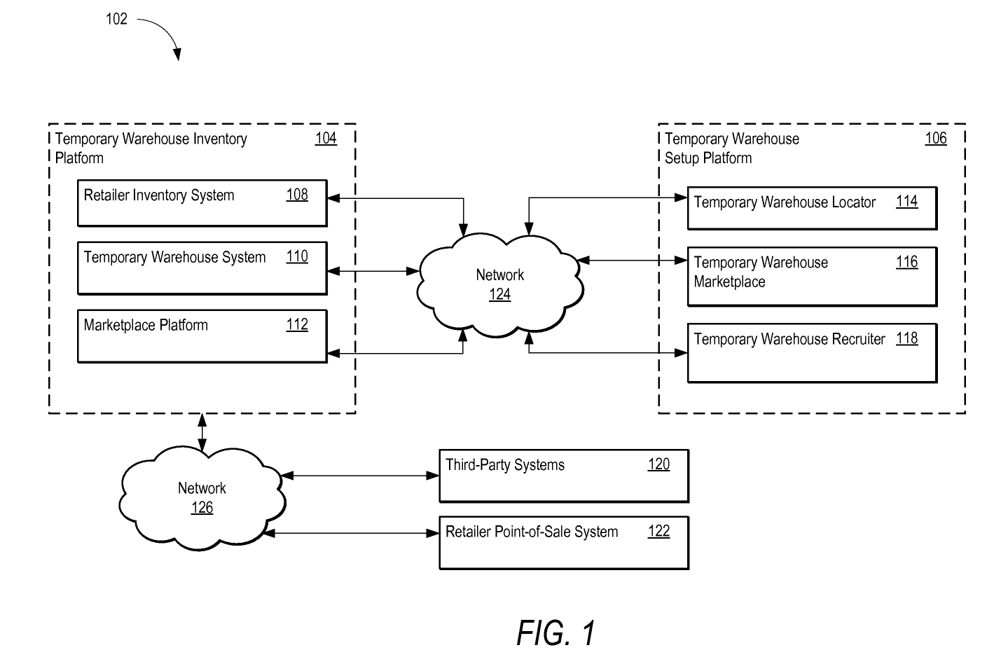

FIG. 1 is an architecture diagram illustrating a temporary warehouse environment 102 that includes a temporary warehouse inventory platform 104 in communication with a temporary warehouse setup platform 106 via a network 124. The temporary warehouse inventory platform 104 is also in communication with other entities via a network 126, such as one or more third-party systems 120, a retailer point-of-sale (“PoS”) system 122, and other such systems. To avoid obscuring the inventive subject matter with unnecessary detail, various functional components (e.g., modules and engines) that are not germane to conveying an understanding of the inventive subject matter have been omitted from FIG. 1. However, a skilled artisan will readily recognize that various additional functional components may be supported by the temporary warehouse environment 102 to facilitate additional functionality that is not specifically described herein.

While the temporary warehouse environment 102 shown in FIG. 1 employs a client-server architecture, the disclosed subject matter is, of course, not limited to such an architecture, and could equally well find application in other architectures, such as an event-driven, distributed, or peer-to-peer architecture system. Further, the various functional components of the temporary warehouse inventory platform 104 and the temporary warehouse setup platform 106 may be implemented as standalone systems or software programs, which do not necessarily have networking capabilities. Moreover, it shall be appreciated that although the various functional components of the temporary warehouse inventory platform 104 and the temporary warehouse setup platform 106 are discussed in the singular sense, multiple instances of one or more of the various functional components may be employed.

When a retailer decides that a temporary warehouse may be desirable, the retailer may be unsure as to the process for establishing such a facility. Accordingly, the temporary warehouse setup platform 106 includes various components to ease the burden on the retailer and to facilitate establishing a temporary warehouse. In this regard, and in one embodiment, the temporary warehouse setup platform 106 includes a temporary warehouse locator 114, a temporary warehouse marketplace 116, and a temporary warehouse recruiter 118.

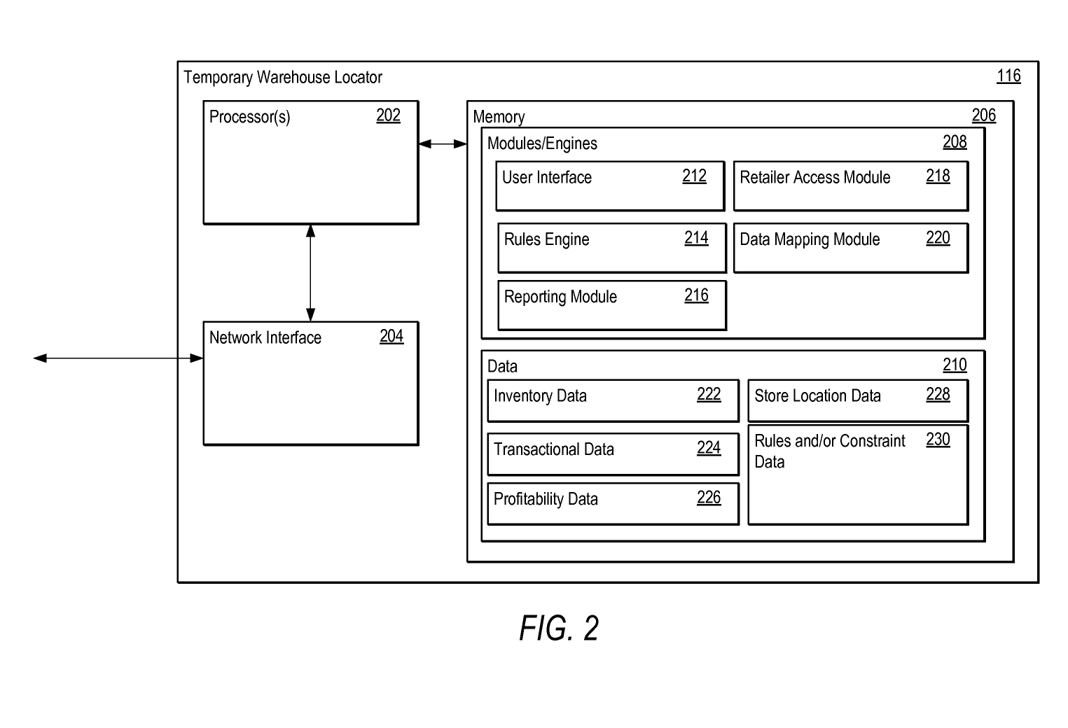

The temporary warehouse locator 114 is configured to identify various geographic locations for a temporary warehouse based upon various conditions and inputs that the retailer may provide. As discussed below with reference to FIG. 2, these conditions and inputs may include information regarding prior transactions conducted by the retailer, such as whether one or more transactions are seasonal or ongoing, the items ordered during the transaction, shipping addresses for the ordered items (including origination addresses and destination addresses), the speed of delivery for the ordered items of the transactions (e.g., 2-day, overnight, etc.), and the manner of payment used in conducting the transaction. These conditions and inputs may also include forecast data, such as potential sales, potential customers, potential profits, and other such forecast data.

Based upon these conditions and inputs, the temporary warehouse locator 114 identifies various geographic locations where the retailer may benefit from a temporary warehouse. Furthermore, the temporary warehouse locator 114 may account for operating costs in the identified geographic locations, which may influence whether the retailer selects a given geographic location for a temporary warehouse.

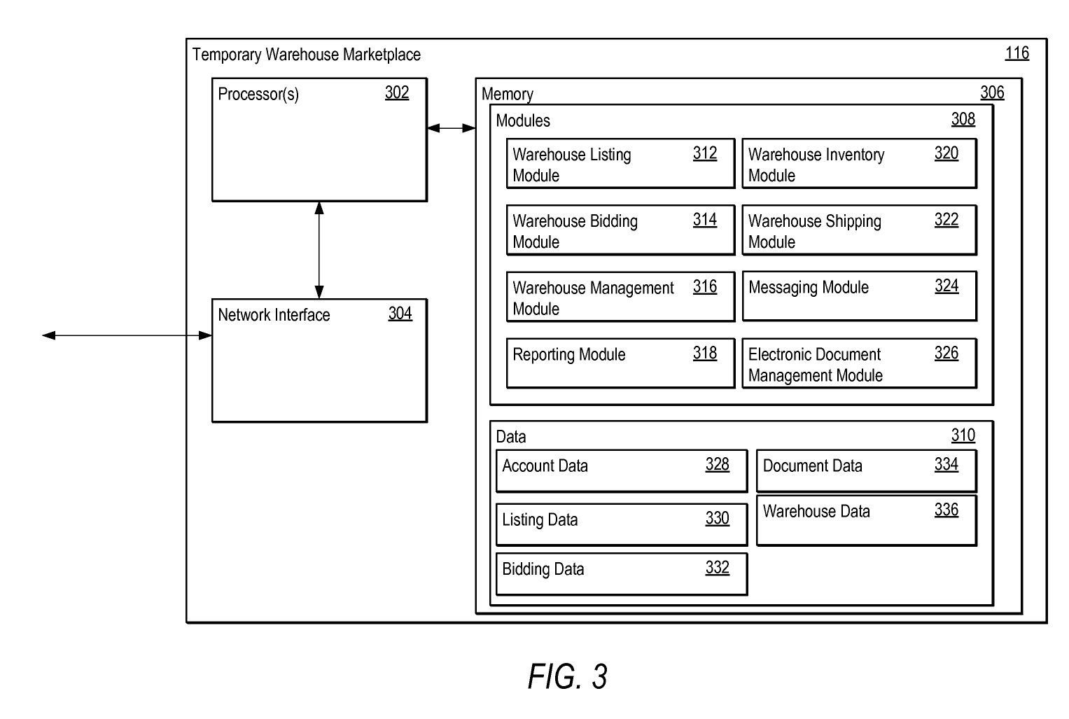

While the retailer may attempt to pursue properties in the geographic locations identified by the warehouse locator 114, the temporary warehouse setup platform 106 includes a temporary warehouse marketplace 116 to help connect the retailer with a need for the temporary warehouse with owner or operators of properties that can satisfy this need. In one embodiment, and as discussed below with reference to FIG. 3, the temporary warehouse marketplace 116 serves as an intermediary between the retailer and the owner or operators of properties. In addition, the temporary warehouse marketplace 116 may be operated as an auction, where retailers can list requirements for a temporary warehouse and owners/operators can bid on those listings. The winning owner/operator may then engage in a transaction with the retailer that results in the retailer renting or leasing property (in whole or in part) from the owner/operator for the temporary warehouse. Accordingly, the temporary warehouse marketplace 116 includes (or communicates with) an electronic document management system so that the parties (e.g., the retailer and the owner/operator) to the transaction can exchange and execute documents to finalize the transaction. Finally, the temporary warehouse marketplace 116 includes applications or modules that allow the retailer to manage the property, now designated as the temporary warehouse, such as ordering inventory, ordering stock, tracking and notifying shipments, and other such actions to keep the temporary warehouse operating on a day-to-day basis.

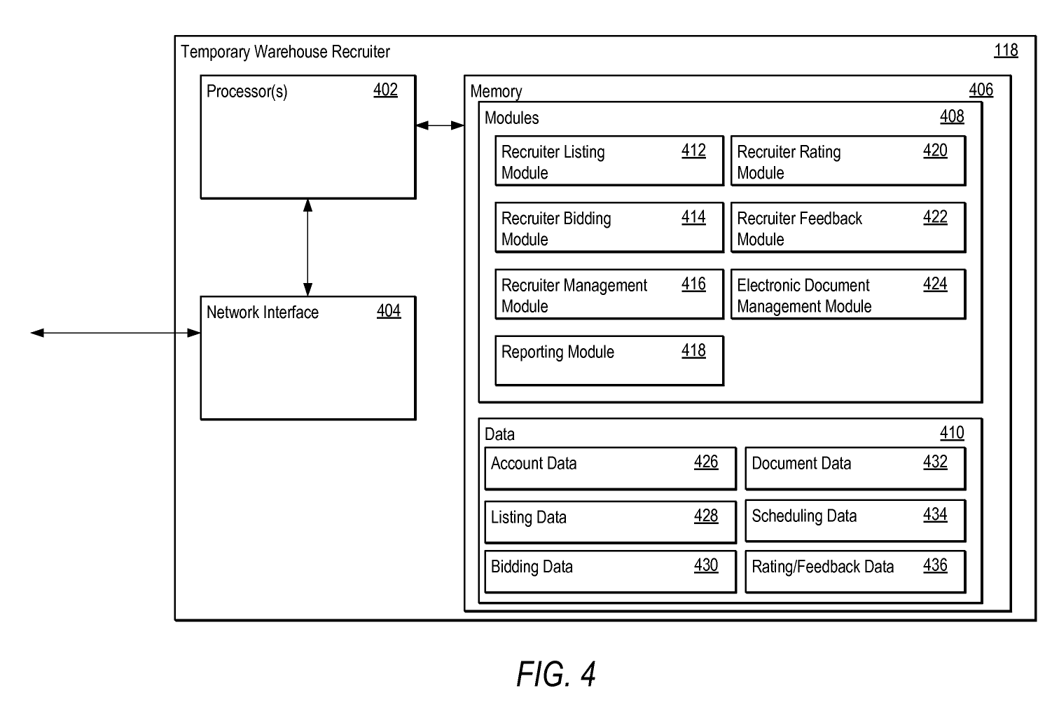

Having settled upon a property to use as a temporary warehouse, the retailer may also need a workforce to run it. Accordingly, the temporary warehouse setup platform 106 includes a temporary warehouse recruiter 118, which facilitates the selection and hiring of employees for the temporary warehouse. To that end, and as discussed below with reference to FIG. 4, the temporary warehouse recruiter 118 serves as an intermediary between the retailer (or its agents) and potential employees for the temporary warehouse. In addition, the temporary warehouse recruiter 118 may be operated as an auction, where the retailer can list requirements for various open positions and job seekers can bid on those open positions. The winning job seeker may then engage in a transaction with the retailer that results in the retailer employing the job seeker at the temporary warehouse. Accordingly, the temporary warehouse recruiter 118 includes (or communicates with) an electronic document management system so that the parties (e.g., the retailer and the job seeker) to the transaction can exchange and execute documents to finalize the transaction. Finally, the temporary warehouse recruiter 118 includes applications or modules directed to user profile account management, which allows a job seeker to maintain an online account with the temporary warehouse recruiter 118 and for the retailer to rate and/or provide feedback on the employment performance for a given employee having an online account with the temporary warehouse recruiter 118.

In addition to helping a retailer set up a temporary warehouse, the temporary warehouse environment 102 also includes a platform directed to accepting orders and managing shipments to customers. The temporary warehouse inventory platform 104 includes various systems and/or modules that cooperate to facilitate order fulfillment by the temporary warehouse. These systems and/or modules may include a retailer inventory system 108, a temporary warehouse system 110, and a merchant marketplace platform 112.

The retailer inventory system 108 may include the retailer's order management system and may automate and streamline order processing for the retailer. The retailer inventory system 108 may provide updated inventory information, a database of vendors, a database of customers, a record of customer returns and refunds, information on billing and payments, order processing records, and general ledger information. Furthermore, the retailer inventory system 108 may access, or provide access to, one or more of the systems and/or platforms, such as the temporary warehouse locator 114, the temporary warehouse marketplace 116, the temporary warehouse system 110, and other such systems in the temporary warehouse environment 102. By having access to the retailer inventory system 108, the systems of the temporary warehouse environment 102 can obtain updated inventory information, customer information, shipping information, and other such information in setting up the temporary warehouse, re-stocking the temporary warehouse, or in handling orders once the temporary warehouse is up and running.

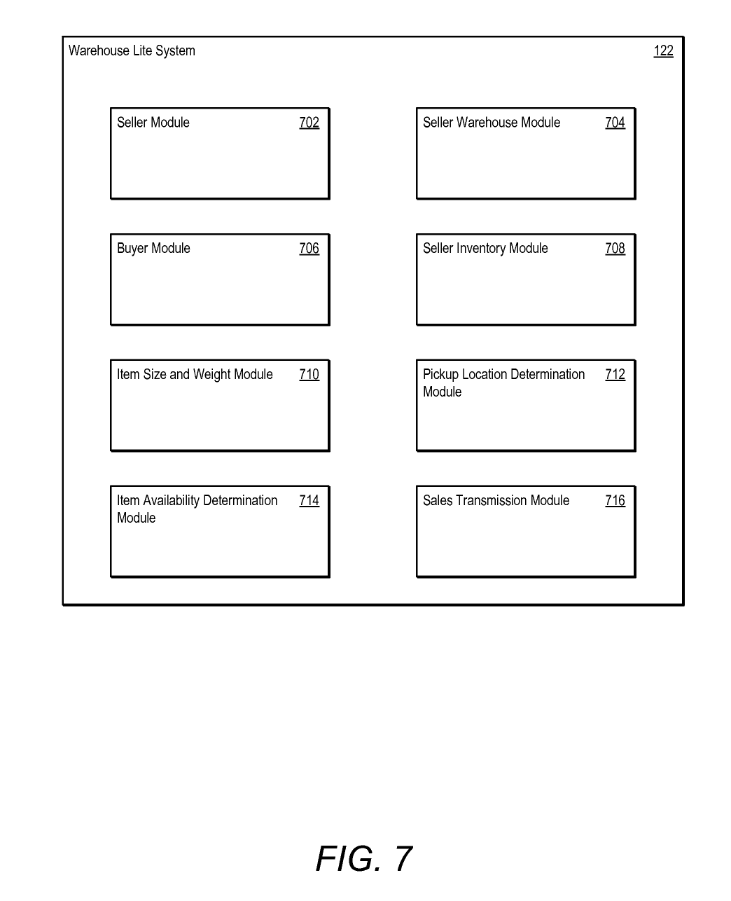

The temporary warehouse system 110 is configured to setup, ramp up and execute many functions for operating the temporary warehouse. As discussed below with reference to FIG. 7, the temporary warehouse system 110 may include various applications and/or modules that facilitate receiving orders from customers, processing those orders, keeping track of sales and/or inventory, and other such services or actions performed by the temporary warehouse.

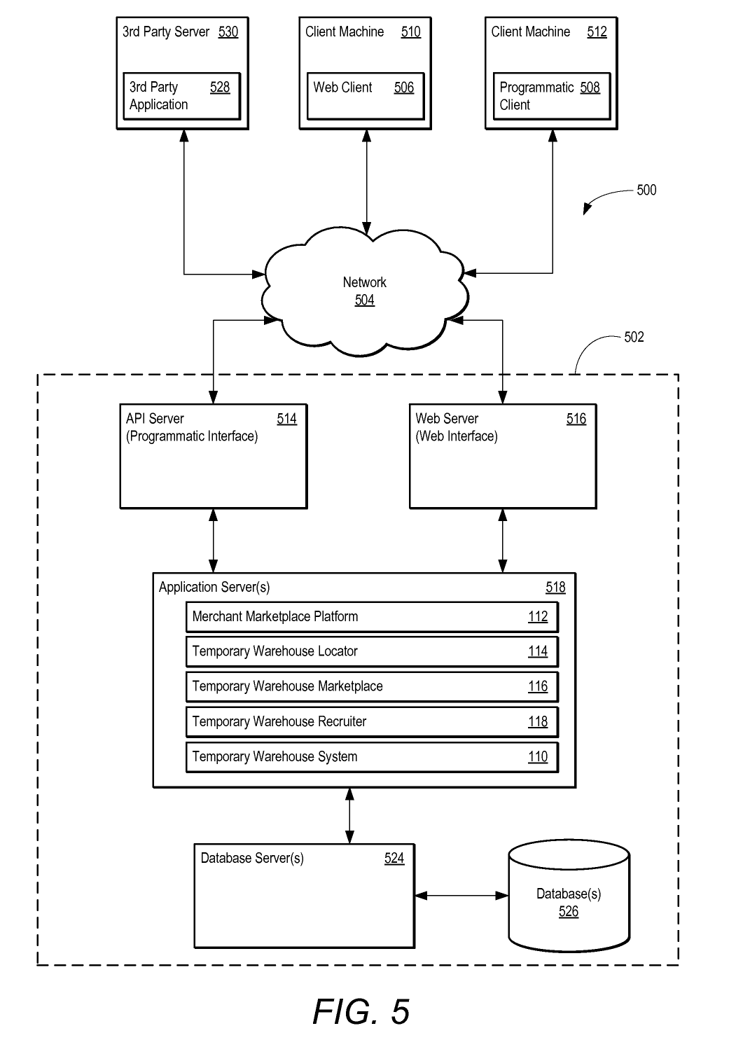

The marketplace platform 112 is configured to provide listings and price-setting mechanisms whereby a user may be a seller or buyer who lists or buys goods and/or services (e.g., for sale) published on the merchant marketplace platform 112. The marketplace platform 112 may also act as a portal to other platforms and/or systems, such as the temporary warehouse setup platform 106 (and the systems 114-118 therein) and the temporary warehouse system 110, so that these platforms can leverage the applications and/or modules provided by the marketplace 112. As discussed below with reference to FIG. 5, the marketplace platform 112 may include various modules which the systems of the temporary warehouse environment 102 may access or invoke (e.g., through a programmatic or web-based interface) in completing various tasks.

The various platforms and systems of the temporary warehouse environment 102 may communicate via one or more networks 124,126. The networks 124,126 may include one or more wireless connections, such as a Wi-Fi connection (e.g., 802.11a/b/g/n), a Worldwide Interoperability for Microwave Access (WiMAX) connection, Bluetooth®, another type of wireless data connection, or combinations thereof. Accordingly, the networks 124,126 may include one or more wireless access points coupled to a local area network (LAN), a wide area network (WAN), such as the Internet, or other packet-switched or circuit-switched data network. In other instances, the connections to the networks 124,126 may be a wired connection, for example, an Ethernet link, and the networks 124,126 may be a LAN, a WAN, the Internet, or other packet-switched or circuit-switched data network.

In addition, while FIG. 1 illustrates that the temporary warehouse inventory platform 104 and the temporary warehouse setup platform 106 as being separate, one of ordinary skill in the art will recognize that the platforms 104,106 may be implemented using the same set of hardware and/or software resources (e.g., one or more processors, various types of computer-readable memories, various types of input and/or output devices, etc.). Thus, and as one example, while the temporary warehouse system 110 is illustrated as being separate from the temporary warehouse marketplace 116, the temporary warehouse system 110 and the temporary warehouse marketplace 116 may be implemented on the same server using the same set of computing resources. Furthermore, the systems 108-118 of the platforms 104,106 may be implemented in a distributed computing environment, where the set of computing resources used to implement the systems 108-118 are distributed across multiple computers regardless of the physical distances between such computers. Thus, the arrangement of the temporary warehouse environment 102 is illustrative as a logical arrangement of the systems 108-118 and in no way should be construed as limiting the physical implementations of such systems 108-118.

FIG. 2 illustrates a block diagram of a temporary warehouse locator 114 according to an example embodiment. In one embodiment, the temporary warehouse locator 114 includes one or more processors 202, a network interface 204, and a memory 206. As shown, the various components 202-206 of the temporary warehouse locator 114 may be configured to communicate with each other (e.g., via a bus, shared memory, a switch, or application programming interfaces (APIs)). In addition, the various components 202-206 of the temporary warehouse locator 114 may reside on a single computer or may be distributed across several computers in various arrangements. The various components 202-206 of the temporary warehouse locator 114 may, furthermore, access one or more databases. Further, while some of the components 202-206 of FIG. 2 are discussed in the singular sense, it will be appreciated that in other embodiments multiple instances of the components may be employed.

The one or more processors 202 may be any type of commercially available processor, such as processors available from the Intel Corporation, Advanced Micro Devices, Texas Instruments, or other such processors.

The network interface(s) 204 may be configured to send to and/or receive data from one or more entities, such as the systems 108-112 of the temporary warehouse inventory platform 104, a third-party system 120, or any of the other systems 116-118 of the temporary warehouse setup platform 106. Furthermore, the network interface(s) 204 may include any number or combination of wired and/or wireless interfaces, such as an Ethernet interface, an 802.11g/n interface, a Bluetooth® interface, or any other such network interface.

The memory 206 is configured with various modules, engines, and/or applications 212-220 in determining potential geographic locations for a temporary warehouse. The memory 206 may include one or more of a hard drive, flash memory, optical drive, magnetic tape drive, or other such non-transitory, computer-readable media, and may further include combinations of the foregoing (e.g., a combination of hard drives, flash memory, and/or optical drives).

As understood by one of ordinary skill in the art, the modules 212-220 may represent a set of executable software instructions and the corresponding hardware (e.g., memory and processor) for executing the instructions. To avoid obscuring the subject matter with unnecessary detail, various applications that are not germane to conveying an understanding of the inventive subject matter have been omitted from FIG. 2. However, a skilled artisan will readily recognize that various additional applications, engines, modules, etc., may be used with the temporary warehouse locator 114 to facilitate additional functionality that is not specifically described herein.

The memory 206 is also configured with data 210 that supports the various modules and/or engines 208. The data 210 may include one or more datastores and may be organized as one or more databases, one or more flat files, or a combination of such datastores. In addition, the data 210 may be local to the temporary warehouse locator 114 and/or may reside across multiple systems, such as those employed in a distributed computing environment.

In one embodiment, the modules/engines 208 include a user interface 212, a rules engine 214, a reporting module 216, a retailer access module 218, and a data mapping module 220. In alternative embodiments, the modules/engines 208 may include alternative or different combinations of the user interface 212, rules engine 214, reporting module 216, retailer access module 218, and data mapping module 220.

The user interface 212 is configured to receive input from a user for the temporary warehouse locator 118 and output information to the user. The user interface 212 may be graphical user interface (“GUI”) and may be accessible programmatically, through an Internet-based browser (e.g., a web GUI), or a combination thereof. As discussed below with reference to the reporting module 216, the user interface 212 may display information about determined geographic locations for one or more temporary warehouses. Furthermore, the user interface 212 may include manipulatable elements for adjusting the output presented to the user, such as radio buttons, sliders, text boxes, and other such user interface elements.

The retailer access module 218 is configured to access retailer-specific information in assessing potential geographic locations for one or more temporary warehouses. The retailer access module 218 may also be configured to allow access to the temporary warehouse locator 114 such that a retailer may obtain any of the data 210 leveraged by the temporary warehouse locator 114, including the determined geographic locations for one or more temporary warehouses.

In one embodiment, and with reference to FIG. 1, the retailer access module 218 accesses the retailer inventory system 108 (or other order management system) to obtain transactional and profitability information from the retailer. The transactional information may include whether one or more transactions are seasonal or ongoing, the items ordered during the transactions, shipping addresses for the ordered items (including origination addresses and destination addresses), the speed of delivery for the ordered items of the transactions (e.g., 2-day, overnight, etc.), and the manner of payment used in conducting the transaction (e.g., credit card, debit card, electronic payment system, etc.). The retailer access module 218 may also obtain profitability information from the retailer inventory system 108, such as projected sales for a given timeframe (e.g., a weekly, quarterly, annually, etc.), projected profits or profits for a given timeframe, project costs or costs for a given timeframe, the expected number of customers or customers for a given timeframe, and other such information.

The retailer access module 218 may also access information about existing storefronts for the retailer (e.g., where the retailer has a preexisting presence). The storefront information obtained by the retailer access module 218 may include such information as the location (e.g., address) for one or more storefronts, the distances between storefronts (which may also be computed by the rules engine 214), whether any storefronts offer in-store pick-up for items ordered from the retailer, whether any storefronts can serve as a destination point for shipping items ordered from the retailer, and other such storefront information. In one embodiment, the storefront information is stored as the store location data 228.

The transactional, profitability, and storefront information obtained by the retailer access module 218 may be driven by the rules and/or constraint data 230. As discussed below with reference to the rules engine 214, the rules engine 214 may leverage various rules and/or constraints in determining geographic locations for one or more temporary warehouses. To evaluate the rules and/or constraints, the rules engine 214 may require input data from the retailer that aligns with a given rule or constraint. Accordingly, the retailer access module 218 may query the rules engine 214 as to the kind of input data the rules engine 214 requires from the retailer and, based upon the reply from the rules engine 214, may then fetch such data from the retailer inventory system 108.

Alternatively, or in addition, the temporary warehouse locator 114 may obtain the transactional, profitability, and/or storefront information via the user interface 212. For example, some of the information about the retailer may not be retained by the retailer inventory system 108, in which case, the temporary warehouse locator 114 may prompt a user via the user interface 212 to provide such missing information.

The information obtained by the retailer access module 218 may be stored as the inventory data 222, the transactional data 224, the profitability 226, and the store location data 228. However, the retailer inventory system 108 may store the data obtained by the retailer access module 218 according to a database schema (or other arrangement) different from the way the temporary warehouse locator 114 stores such data. Accordingly, and in one embodiment, the temporary warehouse locator 114 includes a data mapping module 220 that maps the data structure of the retailer inventory system 108 to the data structure of the temporary warehouse locator 114. In one embodiment, mapping the data obtained from the retailer inventory system 108 includes associating data fields of the retailer inventory system 108 with corresponding data fields of the temporary warehouse locator 114.

In implementing the data mapping module 220, the data mapping module 220 may be specifically configured to associate the data structure of the retailer inventory system 108 with the data structure of the temporary warehouse locator 114. Alternatively or additionally, the data mapping module 220 may be configurable in that the user may provide the data mapping to the data mapping module 220 via the user interface 212. Further still, the data mapping module 220 may prompt the user, via the user interface 212, to provide such mapping based on various conditions (e.g., the first time the retailer access module 218 access the retailer inventory system 108, when a mismatch occurs in the number of data fields obtained from the retailer inventory system 108 versus the number of data fields maintained by the temporary warehouse locator 114, etc.).

Having obtained the various types of information about the retailer, the temporary warehouse locator 114 may then invoke the rules engine 214 to evaluate the rules and/or constraints 230 against the obtained retailer information. In one embodiment, the rules engine 214 is a constraint-based linear optimizer, and the rules and/or constraint data 230 includes rules and/or constraints rules and/or constraints 230 that the rules engine 214 evaluates given the various retailer information (e.g., transaction information, storefront information, profitability information, etc.) previously provided. Examples of such rules include:
1. “If shipping costs for Y>X % of revenue for Y, then identify Y as a geographic location for a temporary warehouse,” where:
   Y is a geographic location (e.g., a city); and
   X is any number between 0 and 100, inclusive;
2. “For a given Y, if the revenue is greater than X and the distance to any given storefront from Y is greater than Z, then identify Y as a geographic location for a temporary warehouse,” where:
   Y is a geographic location (e.g., a city);
   X is any currency amount; and
   Z is any distance.

Using the examples above, the various variables (e.g., X, Y, and Z) may be selectable or configurable by a user or another system, such that the user may use the user interface 212 (or another system may use the retailer access module 218) to provide one or more values or a range of values for the rules engine 214 to evaluate. Furthermore, the rules and/or constraint data 230 may be extensible, such that a user or system may introduce additional or different rules and/or constraint to the rules engine 214. As the rules engine 214 may be a constraint-based linear optimizer, the rules engine 214 may attempt to evaluate the various rules and/or constraints simultaneously, such that the resulting geographic locations represent optimal (or nearly optimal) solutions.

In determining the geographic locations for temporary warehouses, the rules engine 214 may interact with the reporting module 216 to display the geographic locations. In one embodiment, the reporting module 216 provides a heatmap of geographic locations to the user interface 212 for display. The heatmap of geographic locations may indicate a gradient of geographic locations where one or more temporary warehouses may be established. The gradient may include a degree of desirability for the temporary warehouse, which may be assigned a predetermined color selected from a spectrum indicating least desirable to most desirable. In addition, the user may manipulate the heatmap, via the user interface 212, to change its visualization. For example, the user may use one or more manipulatable elements (e.g., sliders, text boxes, check boxes, radio buttons, etc.) to change such factors displayed on the heatmap as profitability, revenue, shipping costs, delivery speed, and other such factors.

In displaying the heatmap of geographic locations, the reporting module 216 may also overlay information on the heatmap to help the retailer in selecting a geographic location for a temporary warehouse. One type of information that the reporting module 216 may overlay is operating cost for businesses in or near the determined geographic locations. For example, the retailer access module 218 may be configured to retrieve business operating costs for a geographic location from a third-party provider, and such operating costs may be incorporated into the report provided by the reporting module 216. As another example, the temporary warehouse locator 114 may be configured with profitability data 226 that includes the operating costs for business in one or more geographic locations. By providing an integrated view of geographic locations that includes retailer-specific information and operating cost information from third parties, the temporary warehouse locator 114 helps a retailer make a more informed, and cost-sensitive, decision about where to establish one or more temporary warehouses. Furthermore, the displayed operating costs may be configurable, such that the retailer may limit the geographic locations displayed or presented based upon an acceptable operating cost. In one embodiment, the retailer provides the acceptable operating cost as an input to the reporting module 216, which may then limit the display of the geographic locations based on the received acceptable operating cost.

While the reporting module 216 may provide a heatmap of geographic locations, other report types are also possible. For example, the reporting module 216 may provide a list of geographic locations where one or more temporary warehouses could be established. The reporting module 216 may also provide an API-formatted response, such as JSON or SOAP response, to a user or system that invoked the rules engine 214. The API-formatted response may be useful where the temporary warehouse locator 114 is used in a service-oriented architecture (“SOA”) or as part of a larger workflow for establishing the temporary warehouses.

The retailer may then use the determined geographic locations to seek out owners or operators of property in those determined geographic locations to establish the temporary warehouse. In particular, the retailer may turn to the temporary warehouse marketplace 116 to find such operators or owners. FIG. 3 illustrates a block diagram of the temporary warehouse marketplace 116 according to an example embodiment. In one embodiment, the temporary warehouse marketplace 116 includes one or more processors 302, a network interface 304, and a memory 306. As shown, the various components 302-306 of the temporary warehouse marketplace 116 may be configured to communicate with each other (e.g., via a bus, shared memory, a switch, or application programming interfaces (APIs)). In addition, the various components 302-306 of the temporary warehouse marketplace 116 may reside on a single computer or may be distributed across several computers in various arrangements. The various components 302-306 of the temporary warehouse marketplace 116 may, furthermore, access one or more databases. Further, while some of the components 302-306 of FIG. 3 are discussed in the singular sense, it will be appreciated that in other embodiments multiple instances of the components may be employed.

The one or more processors 302 may be any type of commercially available processor, such as processors available from the Intel Corporation, Advanced Micro Devices, Texas Instruments, or other such processors.

The network interface(s) 304 may be configured to send to and/or receive data from one or more entities, such as the systems 108-112 of the temporary warehouse inventory platform 104, a third-party system 120, or any of the other systems 114,118 of the temporary warehouse setup platform 106. Furthermore, the network interface(s) 304 may include any number or combination of wired and/or wireless interfaces, such as an Ethernet interface, an 802.11 g/n interface, a Bluetooth® interface, or any other such network interface.

The memory 306 is configured with various modules, engines, and/or applications 312-324 for arranging transactions between the retailer looking for a property to host the temporary warehouse and owners and/or operators of such properties. The memory 306 may include one or more of a hard drive, flash memory, optical drive, magnetic tape drive, or other such non-transitory, computer-readable media, and may further include combinations of the foregoing (e.g., a combination of hard drives, flash memory, and/or optical drives).

As understood by one of ordinary skill in the art, the modules 312-324 may represent a set of executable software instructions and the corresponding hardware (e.g., memory and processor) for executing the instructions. To avoid obscuring the subject matter with unnecessary detail, various applications that are not germane to conveying an understanding of the inventive subject matter have been omitted from FIG. 3. However, a skilled artisan will readily recognize that various additional applications, engines, modules, etc., may be used with the temporary warehouse marketplace 116 to facilitate additional functionality that is not specifically described herein.

The memory 306 is also configured with data 310 that supports the various modules and/or engines 308. The data 310 may include one or more datastores and may be organized as one or more databases, one or more flat files, or a combination of such datastores. In addition, the data 310 may be local to the temporary warehouse marketplace 116 and/or may reside across multiple systems, such as those employed in a distributed computing environment.

In one embodiment, the modules/engines 308 include a warehouse listing module 312, a warehouse bidding module 314, a warehouse management module 316, a reporting module 318, a warehouse inventory module 320, a warehouse shipping module 322, a messaging module 324, and an electronic document management module 326. In alternative embodiments, the modules/engines 308 may include alternative or different combinations of such modules.

The warehouse listing module 312 is configured to generate listings of property types that a retailer may prefer in searching for a property to host (or act as) the temporary warehouse. In generating the listing, the warehouse listing module 312 may reference data 310 stored by the temporary warehouse marketplace 116, such as the listing data 330. The listing data 330 may be provided by the retailer in generating the listing and/or may be obtained from other sources, such as the retailer inventory system 108 or the marketplace platform 112.

A listing for a property may include various characteristics that a retailer would like for the temporary warehouse. These characteristics may include a geographic location or predetermined distance from a geographic location (e.g., one or more of the geographic locations determined by the temporary warehouse locator 114), a preferred size for the property, a preferred industry for the property (e.g., electronics, footwear, clothing, kitchenware, etc.), a preferred building type for the property (e.g., retail storefront, free standing building, etc.), and other such characteristics. In generating the listing, and with reference to FIG. 2, the retailer may use the report generated by the temporary warehouse locator 114 to identify geographic locations, select a geographic location using the user interface 212, apply various filters to the generated report via the reporting module 216 (e.g., available properties, businesses in or near the determined geographic locations, industry types in or near the determined geographic locations), and then generate a listing via the warehouse listing module 312 using the selected filters and/or geographic locations of the report prepared by the reporting module 216. These characteristics, along with the various details of the listing, may be stored by the temporary warehouse marketplace 116 as listing data 330. Furthermore, various listings stored in the listing data 330 may be associated with an account established by the retailer and stored as account data 328. Thus, an account associated with a retailer may be associated with multiple listings for desired properties in multiple geographic locations.

The generated listing also includes a fee, which may represent an amount the retailer is willing to pay an owner or operator for a desired property type or an amount the owner or operator of a property is willing to pay the retailer. Alternatively or additionally, the fee may represent an amount the retailer or the owner/operator is willing to pay upon a successful bid for the listing. The generated listing may also include a duration that the retailer intends to use the property as a temporary warehouse (e.g., days, weeks, months, etc.). As discussed below with reference to the warehouse bidding module 314, this fee may change depending on the number of property owners or operators that bid on the listing for the temporary warehouse. Alternatively or additionally, the fee may be adjusted (e.g., increased or decreased) based upon other conditions such as the frequency of the bids, the time elapsed since the listing was made available, and other such conditions or combination of conditions.

The temporary warehouse marketplace 116 may implement an auction-like system in soliciting bids for generated listings. Accordingly, the temporary warehouse marketplace 116 may support various auction types and/or price setting mechanisms (e.g., English, Dutch, Vickrey, Chinese, Double, Reverse auctions etc.). The warehouse listing module 312 and/or the warehouse bidding module 314 may also provide a number of features in support of such auction-format listings, such as an acceptance price feature whereby the retailer may specify an acceptance price in connection with a listing and a proxy-bidding feature whereby a bidder may invoke automated proxy bidding. Should a property owner or operator agree to the acceptance price, such as before auctioning has commenced or during auctioning, the warehouse listing module 312 may terminate receiving offers for the listing and initiate a transaction between the retailer and the owner and/or operator of the property that agreed to the acceptance price. In one embodiment, the acceptance price represents an amount the retailer is willing to pay to use a property as a temporary warehouse. In another embodiment, the acceptance price represents an amount the property owner and/or operator is willing to pay the retailer to use the property as the temporary warehouse.

To solicit bids from property owners and operators, the temporary warehouse marketplace 116 implements a warehouse bidding module 314 in accordance with an example embodiment. The warehouse bidding module 314 may be configured to generate and submit bids on behalf of property owners and operators. In generating the bid, the warehouse bidding module 313 may reference the account data 328, which may include information about an owner and/or operator submitting the bid. The bid submitted by the owner or operator may be stored as bidding data 332 and may be associated with the owner/operator account stored in the account data 328. Thus, an owner and/or operator account may be associated with multiple bids (via the bidding data 332) of multiple listings (via the listing data 330).

During the bidding process, the fee associated with the generated listing may change based on a predetermined number of bids submitted for the listing. For example, the fee may decrease as the number of bids increases or the fee may increase as the number of bids increases. The change in the fee may eliminate those property owners and/or operators that are not committed to using their property as a temporary warehouse.

When a bid is successful, either by outbidding other bids or by agreeing to the acceptance price, the warehouse bidding module 314 may invoke the messaging module 324, which allows the parties to communicate, such as by e-mail, video conferencing, or other means. Furthermore, the messaging module 324 is also configured to facilitate communications between the retailer and the property owner/operator, which may be helpful to the retailer should the retailer have any questions about using a given property as the temporary warehouse.

While the foregoing description of the warehouse listing module 312 and the warehouse bidding module 314 relate to an auction-based process, other types of listing processes may be implemented. For example, the warehouse listing module 312 may list a retailer's request for a temporary warehouse and the warehouse bidding module 314 may accept offers from owners and/or operators to fulfil the retailer's request. The retailer may then review such offers and select one that the retailer finds desirable. In this implementation, the listing of the temporary warehouse may be an invitation to accept offers (e.g., bids), and the number of bids received may not affect the characteristics of the listing (e.g., the fee associated with the listing). Alternatively or additionally, the retailer may select how the temporary warehouse marketplace 116 is to solicit offers for the listing, such as whether the listing should be provided in an auction-based process or a non-auction process.

Before bid processing is completed and/or the transaction between the retailer and the owner/operator is formalized, the retailer may desire to preview or view the property about to be used as the temporary warehouse. Accordingly, and in one embodiment, the temporary warehouse marketplace 116 includes warehouse data 336, which includes a datastore for the details regarding a property offered by an owner/operator for the temporary warehouse. The warehouse data 336 may further include data about the various properties offered through the warehouse bidding module 314 so that other retailers can preview prospective available properties before creating listing for the temporary warehouse. However, as discussed below, the warehouse data 336 may not be limited to information about the characteristics for a given property, but may also include operational data for the property once the property is designated and used as the temporary warehouse.

As the parties to a transaction are likely to sign agreements (e.g., a leasing or sub-leasing agreement), the temporary warehouse marketplace 116 also implements, in one embodiment, an electronic document management module 326. The electronic document management module 326 is configured to accept electronic documents from the parties (e.g., a scanned leasing agreement) and present the electronic documents for electronic signing. In one embodiment, the electronic document management module 326 may accept documents submitted in a Portal Document Format (“PDF”), and then use public key cryptography for signing and authenticating signatures.

In an alternative embodiment, the electronic document management module 326 may facilitate access to a third-party document management system, such as Adobe® EchoSign®, which is available from Adobe Systems Incorporated. In this embodiment, the documents the parties are required to sign may be communicated via the electronic document management module 326 to the third-party document management system, which may then communicate the electronic documents to the respective parties for signing, and then communicate the signed electronic documents back to the temporary warehouse marketplace 116. Accordingly, and in one embodiment, the temporary warehouse marketplace 116 includes document data 334, which may be a datastore of the electronic documents to be signed and/or executed by the parties to a transaction.

While the electronic document management module 326 has been discussed with respect to signing electronic documents, the electronic document management module 326 may also facilitate access to previously signed documents or documents that an entity (e.g., the retailer) has scanned or electronically generated (e.g., an electronic word processing document). In this way, the electronic document management module 326 acts as a central portal for the retailer, or any party involved in a transaction, to access electronic documents as they are needed or desired.

After the transaction is completed between the retailer and the owner/operator of a given property, the retailer may desire to electronically manage the property. This may be desirable in situations where an executive officer of the retailer would like to view the property being used as the temporary warehouse, but may not be available to physically visit the property. Accordingly, and in one embodiment, the temporary warehouse marketplace 116 includes a suite of warehouse management modules, including a general warehouse management module 316, a warehouse inventory module 320, and a warehouse shipping module 322.

The general warehouse management module 316 may be configured facilitate day-to-day operations of the temporary warehouse. To that end, the general warehouse management module 316 may interface with one or more systems, such as the retailer inventory system 106, the temporary warehouse system 110, the marketplace platform 112, and other such systems. The warehouse management module 316 may also interface with other modules of the temporary warehouse marketplace, such as the warehouse inventory module 320 and/or the warehouse shipping module 322 to provide a detailed view of the inventory housed by the temporary warehouse and shipment tracking for new inventory, inventory being re-stocked, and other such inventory-related actions. Furthermore, where the retailer operates multiple temporary warehouses, the warehouse management module 316 may provide overview information for each of the temporary warehouses, such as by referencing warehouse data 336, which may include information about the various temporary warehouses operated by the retailer. In one embodiment, temporary warehouse data is stored in the warehouse data 336 and is associated with a retailer's account in the account data 328. In this way, the warehouse management module 316 provides a convenient and central interface for the retailer to remotely administer one or more temporary warehouses.

In managing the temporary warehouse, the retailer may desire to keep track of inventory and shipments to the temporary warehouse so that the temporary warehouse maintains a desired level of inventory throughout its lifecycle. According, and in one embodiment, the temporary warehouse marketplace 116 includes the warehouse inventory module 320 and the warehouse shipping module 322, which manage inventory and shipping, respectively. The warehouse inventory module 320 and the warehouse shipping module 322 may communicate with other systems and/or modules, such as the systems 108-112 of the temporary warehouse inventory platform 104, the temporary warehouse locator 114, and/or the temporary warehouse recruiter 118. The warehouse inventory module 320 may be configured to monitor and track inventory levels for a given temporary warehouse, and may further allow the retailer to take an action, such as ordering new inventory, discontinuing a given inventory, etc., based upon the monitored and tracked inventor levels. The warehouse shipping module 322 may be configured to monitor and track shipping to and/or from the temporary warehouse, including orders where the destination is the temporary warehouse (e.g., inventory, supplies, etc.) and/or orders where the destination is a customer or a storefront for the retailer. In this way, the warehouse inventory module 320 and the warehouse shipping module 322 provide a comprehensive view of the inventory stocked by the temporary warehouse and the shipments of such inventory to and/or from the temporary warehouse.

In addition to providing a system for finding potential properties to be used as a temporary warehouse, the temporary warehouse setup platform 106 may also include a system for a retailer to find a workforce to operate and fulfil orders by the temporary warehouse. FIG. 4 illustrates a block diagram of the temporary warehouse recruiter 118 according to an example embodiment. In one embodiment, the temporary warehouse recruiter 118 includes one or more processors 402, a network interface 404, and a memory 406. As shown, the various components 402-406 of the temporary warehouse recruiter 118 may be configured to communicate with each other (e.g., via a bus, shared memory, a switch, or application programming interfaces (APIs)). In addition, the various components 402-406 of the temporary warehouse recruiter 118 may reside on a single computer or may be distributed across several computers in various arrangements. The various components 402-406 of the temporary warehouse recruiter 118 may, furthermore, access one or more databases. Further, while some of the components 402-406 of FIG. 3 are discussed in the singular sense, it will be appreciated that in other embodiments multiple instances of the components may be employed.

While the following description of the temporary warehouse recruiter 118 refers to a “retailer” and “potential employee” as users of the temporary warehouse recruiter 118, this disclosure contemplates that other types of entities may also use the temporary warehouse recruiter 118. For example, a recruiting corporation may establish an account with the temporary warehouse recruiter 118 and place listings for potential employees and/or submit offers (e.g., bids) on behalf of a potential employee for a given listing. Thus, the temporary warehouse recruiter 118 is a powerful tool that may be used by any entity, regardless of whether the entity is a retailer, individual, personnel manager, recruiter, third-party agent, or other such entity.

The one or more processors 402 may be any type of commercially available processor, such as processors available from the Intel Corporation, Advanced Micro Devices, Texas Instruments, or other such processors.

The network interface(s) 404 may be configured to send to and/or receive data from one or more entities, such as the systems 108-112 of the temporary warehouse inventory platform 104, a third-party system 120, or any of the other systems 114,116 of the temporary warehouse setup platform 106. Furthermore, the network interface(s) 404 may include any number or combination of wired and/or wireless interfaces, such as an Ethernet interface, an 802.11 g/n interface, a Bluetooth® interface, or any other such network interface.

The memory 406 is configured with various modules, engines, and/or applications 412-424 for arranging transactions between the retailer (or its agent) looking for employees to operate and/or manage the temporary warehouse. The memory 406 may include one or more of a hard drive, flash memory, optical drive, magnetic tape drive, or other such non-transitory, computer-readable media, and may further include combinations of the foregoing (e.g., a combination of hard drives, flash memory, and/or optical drives).

As understood by one of ordinary skill in the art, the modules 412-424 may represent a set of executable software instructions and the corresponding hardware (e.g., memory and processor) for executing the instructions. To avoid obscuring the subject matter with unnecessary detail, various applications that are not germane to conveying an understanding of the inventive subject matter have been omitted from FIG. 4. However, a skilled artisan will readily recognize that various additional applications, engines, modules, etc., may be used with the temporary warehouse recruiter 118 to facilitate additional functionality that is not specifically described herein.

The memory 406 is also configured with data 410 that supports the various modules and/or engines 408. The data 410 may include one or more datastores and may be organized as one or more databases, one or more flat files, or a combination of such datastores. In addition, the data 410 may be local to the temporary warehouse recruiter 118 and/or may reside across multiple systems, such as those employed in a distributed computing environment.

In one embodiment, the modules/engines 408 include modules configured to manage listings for positions and bids on such listings, such as a recruiter listing module 412 and a recruiter bidding module 414. The modules/engines 408 also includes a module configured to manage potential new employees and current employees, such as the recruiter management module 416. The modules/engines 408 additionally include modules configured to provide feedback on a given employee, such as a recruiter rating module 420 and a recruiter feedback module 422. Further still, the modules/engines 408 include a module configured to manage electronic documents that may be signed by an employee or the retailer (or its agents), such as an electronic document management module 424. Finally, the modules/engines 408 include a module configured to provide various reports on the listings, bids, potential employees, and/or current employees, such as the reporting module 418.

The recruiter listing module 412 is configured to generate listings for open positions that a retailer is looking to fill for a given temporary warehouse. In generating the listing, the recruiter listing module 412 may reference data 410 stored by the temporary warehouse recruiter 118, such as the listing data 428. The listing data 428 may be provided by the retailer in generating the listing and/or may be obtained from other sources, such as the temporary warehouse setup platform 106 and/or the temporary warehouse inventory platform 104.

A listing for an employee may include various characteristics that a retailer would prefer for the potential employee to have in filling the position. These characteristics may include the potential employee's past work history, whether the potential employee has previously worked in a warehouse environment, a predetermined (or configurable) distance of the employee to the temporary warehouse (e.g., the retailer may prefer to hire locally rather than pay relocation costs), whether the potential employee has worked in a given industry, the duration of employment, and other such characteristics. In generating the listing, and with reference to FIG. 2, the retailer may use the report generated by the temporary warehouse locator 114 to identify geographic locations, select a geographic location using the user interface 212, apply various filters to the generated report via the reporting module 216 (e.g., available properties, businesses in or near the determined geographic locations, industry types in or near the determined geographic locations), and then generate a listing via the recruiter listing module 412 using the selected filters and/or geographic locations of the report prepared by the reporting module 216.

These characteristics, along with the various details of the listing, may be stored by the temporary warehouse recruiter 118 as listing data 428. Furthermore, various listings stored in the listing data 428 may be associated with an account established by the retailer and stored as account data 426. Thus, an account associated with a retailer may be associated with multiple listings for open positions for multiple temporary warehouses.

The generated listing may also include a salary, which may represent an amount the retailer is willing to pay a potential employee for the position. The generated listing may also include a duration that position is intended to last (e.g., weeks, months, etc.). Alternatively or additionally, the listing may include a fee that the retailer or the potential employee is willing to pay upon a successful bid for the listing. During the bidding process, the fee may be adjusted (e.g., increased or decreased) based upon various conditions, such as the number of bids received, the frequency of the bids, the time elapsed since the listing was made available, and other such conditions or combination of conditions.

The retailer may elect to run the listing for the open position in an auction-based process or a non-auction-based process. In an auction-based process, the temporary warehouse recruiter 118 may be configured to support various auction types and/or price setting mechanisms (e.g., English, Dutch, Vickrey, Chinese, Double, Reverse auctions etc.). For example, an account for a potential employee may be assigned a number of electronic tokens, and the electronic tokens may be used to bid on a listing. The recruiter listing module 412 and/or the recruiter bidding module 414 may also provide a number of features in support of such auction-format listings, such as an acceptance price feature whereby the retailer may specify an acceptance price in connection with a listing and a proxy-bidding feature whereby a bidder may invoke automated proxy bidding. Should a potential employee agree to the acceptance price, such as before auctioning has commenced or during auctioning, the recruiter listing module 412 may terminate receiving offers for the listing and initiate a transaction between the retailer and the potential employee.

To solicit offers (e.g., bids) from potential employees, the temporary warehouse recruiter 118 implements a recruiter bidding module 414 in accordance with an example embodiment. The recruiter bidding module 414 may be configured to generate and submit bids on behalf of potential employees. In generating the bid, the recruiter bidding module 313 may reference the account data 426, which may include account information for a given potential employee (e.g., a user of the temporary warehouse recruiter 118). The bid submitted by the potential employee may be stored as bidding data 430 and may be associated with the potential employee account stored in the account data 426. Thus, a potential employee account may be associated with multiple bids (via the bidding data 430) of multiple listings (via the listing data 428).

In addition, a potential employee account may include a number of characteristics that the retailer may use to filter bids received from potential employees. These characteristics may include employment history, whether the potential employee has previously worked in a warehouse environment, an employment rating (which may be provided via a recruiter rating module 420), comments and/or feedback regarding the potential employee (which may be provided by the recruiter feedback module 422), and other such employment characteristics. As discussed above, the retailer may use these characteristic types to limit the type of potential employees that may submit bids for a given listing. In addition, the retailer may use these characteristic types as search or filter criteria such that a retailer can view the types of potential employees that have submitted bids for a given listing (e.g., the retailer can view bids associated with potential employees that have previously worked in a warehouse environment, have a given rating, have a preferred number of years of employment history, and so forth).

When a bid is successful, either by outbidding other bids or by agreeing to the acceptance price, the recruiter bidding module 414 may invoke the recruiter management module 416, which, in one embodiment, is configured to facilitate communications between the retailer (or its agent) and the potential employee associated with the winning bid.

While the foregoing description of the recruiter listing module 412 and the recruiter bidding module 414 relate to an auction-based process, other types of listing processes may be implemented. For example, the recruiter listing module 412 may list a position for a temporary warehouse and the recruiter bidding module 414 may accept offers from potential employees to fulfil this position. The retailer may then review such offers and select one that the retailer finds desirable. In this implementation, the listing of the position may be an invitation to accept offers (e.g., bids), and the number of bids received may not affect the characteristics of the listing. Alternatively or additionally, the retailer may select how the temporary warehouse recruiter 118 is to solicit offers for the listing, such as whether the listing should be provided in an auction-based process or a non-auction process.

As the potential employee and the retailer are likely to sign agreements (e.g., an employment agreement, a confidentiality agreement, etc.), the temporary warehouse recruiter 118 also implements, in one embodiment, an electronic document management module 424. The electronic document management module 424 is configured to accept electronic documents from the parties (e.g., a scanned employment agreement, an electronically-generated employment agreement, etc.) and present the electronic documents for electronic signing. In one embodiment, the electronic document management module 424 may accept documents submitted in a Portal Document Format (“PDF”), and then use public key cryptography for signing and authenticating signatures.

In an alternative embodiment, the electronic document management module 424 may facilitate access to a third-party document management system, such as Adobe® EchoSign®. In this embodiment, the documents the parties are required to sign may be communicated via the electronic document management module 424 to the third-party document management system, which may then communicate the electronic documents to the respective parties for signing, and then communicate the signed electronic documents back to the temporary warehouse recruiter 118. Accordingly, and in one embodiment, the temporary warehouse recruiter 118 includes document data 432, which may be a datastore of the electronic documents to be signed and/or executed by the parties to a transaction.

While the electronic document management module 424 has been discussed with respect to signing electronic documents, the electronic document management module 424 may also facilitate access to previously signed documents or documents that an entity (e.g., the retailer) has scanned or electronically generated (e.g., an electronic word processing document). In this way, the electronic document management module 424 acts as a central portal for the retailer, or any party involved in a transaction, to access electronic documents as they are needed or desired.

After the transaction is completed between the retailer and the newly hired employee, the retailer may desire to electronically manage the employee. This may be desirable in situations where there may be multiple work schedules to coordinate, certain employees are unavailable at specific times during the week, certain employees are only capable of performing a specific task, and other such scenarios.

Accordingly, and in one embodiment, the temporary warehouse recruiter 118 includes a recruiter management module 416 configured to allow a retailer to manage one or more employees employed at a given temporary warehouse. For example, the employees may each have an account stored as account data 426. Alternatively or additionally, the retailer may request that an employee enroll with the temporary warehouse recruiter 118 and create an account. The retailer may then manage one or more employees of one or more temporary warehouses via the recruiter management module 416, including scheduling when employees work, when an employee is available or not available, requesting temporary transfers of employees from one temporary warehouse to another temporary warehouse, and other such activities. In one embodiment, the temporary warehouse recruiter 118 includes scheduling data 434, which may be stored in the data 410. The scheduling data 434 may be associated with one or more employee accounts stored in the account data 426 and accessible via the recruiter management module 416. In this way, the recruiter management module 416 provides a centralized environment by which a retailer can manage many different employees, whom may be employed at different temporary warehouses.

In addition, the temporary warehouse recruiter 118 may be configured to receive feedback from a retailer regarding a given employee. In one embodiment, the temporary warehouse recruiter 118 includes a recruiter rating module 420 and a recruiter feedback module 422. The recruiter rating module 420 is configured to accept a rating for a given employee, which may be a numerical, letter, and/or symbolic rating. Furthermore, the rating may be associated with the employee's account such that this rating may be retrieved or viewed should the employee seek out another position listed by the recruiter listing module 412. The recruiter feedback module 422 is configured to accept feedback for a given employee, which may be a preconfigured word and/or phrase, a text-based comment of a given length provided by the retailer, or a combination thereof. Like the recruiter rating module 420, the recruiter feedback module 422 may be configured to associate feedback with an employee's account such that the feedback is retrievable and/or viewable by other retailers (e.g., during the bidding process should the employee seek out another position listed by the recruiter listing module 412). In this way, employees that are exemplary are highlighted and distinguished, which may also increase their desirability and lead to increased chances of employment.

The temporary warehouse recruiter 118 may further include a reporting module 418 configured to provide various types of reports based on the data 410 stored and/or accessible by the temporary warehouse recruiter 118. In on embodiment, the reporting module 418 communicates with the various modules 412-416,420-424 to prepare and deliver reports to the retailer. For example, the reporting module 418 may request, from the recruiter listing module 412, those listings that have received bids. As another example, the reporting module 418 may retrieve, from the account data 426, those employee accounts associated with a specific industry (e.g., electronics). Other types of reports that the reporting module 418 may generate include a listing of which potential employees have prior work experience for a given industry, which potential employees have a designated rating, which listings have received the most and/or fewest number of bids, whether there are more accounts bidding than there are listings (e.g., supply is greater than demand) or vice versa (e.g., demand is greater than supply), and other such reports.

While FIG. 1 illustrates one type of environment 102 for the temporary warehouse inventory platform 104 and the temporary warehouse setup platform 106, other arrangements of these systems are also possible. FIG. 5 illustrates one such alternative arrangement. FIG. 5 is a network diagram depicting a network system 500 having a client-server architecture configured for exchanging data over a network, according to one embodiment. For example, the network system 500 may be a publication/publisher system where clients may communicate and exchange data within the network system 500. The data may pertain to various functions (e.g., online item purchases) and aspects (e.g., managing content and/or scheduling deliveries of purchased items) associated with the network system 500 and its users. Although illustrated herein as a client-server architecture, other embodiments may include other network architectures, such as peer-to-peer or distributed network environments.

A data exchange platform, in an example form of a merchant marketplace platform 112 (e.g. eBay Inc. of San Jose, Calif.) and a temporary warehouse system 110, may provide server-side functionality, via a network 504 (e.g., the Internet) to one or more clients. The one or more clients may include users (e.g. retailers and buyers) that utilize the network system 500 and, more specifically, the merchant marketplace platform 112 and users (e.g. retailers and proprietors of space) that utilize the network system 500 and, more specifically, the temporary warehouse system 110, to exchange data over the network 504. These transactions may include transmitting, receiving (communicating), and processing data to, from, and regarding content and users of the network system 500. The data may include, but is not limited to, content and user data such as user profiles; user attributes; product and service reviews and information, such as pricing and descriptive information; product, service, manufacturer, and vendor recommendations and modules; product and service listings associated with buyers, sellers and/or couriers; auction bids; and transaction data, such as collection and payment, shipping transactions, shipping label purchases, and real time synchronization of financial journals, among others.

In various embodiments, the data exchanges within the network system 500 may be dependent upon user-selected functions available through one or more client or user interfaces (UIs). The UIs may be associated with a client machine, such as a client machine 510 using a web client 506. The web client 506 may be, for example, in communication with the merchant marketplace platform 112 via a web server 516. The UIs may also be associated with a client machine 512 using a programmatic client 508, such as a client application, or a third party server 530 with a third party application 528. It will be appreciated that in various embodiments, the client machines 510, 512, or third party server 530 may be associated with a buyer, a seller, a proprietor, a third party electronic commerce platform, a payment service provider, a shipping service provider, or a financial institution system, each in communication with the networked system 502 and optionally with each other. The buyers, sellers and proprietors may be any one of individuals, merchants, or other service providers.

Turning specifically to the merchant marketplace platform 112 and the various temporary warehouse systems 110,114-118, an application program interface (API) server 514 and a web server 516 are coupled to, and provide programmatic and web interfaces respectively to, one or more application servers 518, which include one or more implementations of the temporary warehouse system 110, the merchant marketplace platform 112, the temporary warehouse locator 114, the temporary warehouse marketplace 116, and the temporary warehouse recruiter 118. Thus, while the various systems 114-118 may be implemented as logically separate components, the systems 114-118 may be implemented on the same set of hardware as the marketplace platform 112 and/or the temporary warehouse system 110.

The application server(s) 518 is, in turn, shown to be coupled to one or more database servers 524 that facilitate access to one or more databases 526 which may include information such as user profiles (for buyers, sellers and proprietors), map data, historical sales data, historical rent value data for localities, etc. In addition, the data leveraged by the temporary warehouse locator 114, the temporary warehouse marketplace 116, and/or the temporary warehouse recruiter 118 may be stored in one or more of the databases 526 and accessible by the one or more database servers 524.

In one embodiment, the web server 516 and the API server 514 communicate and receive data pertaining to listings and transactions, among other things, via various user input tools. For example, the web server 516 may send and receive data to and from a toolbar or webpage on a browser application (e.g., web client 506) operating on a client machine (e.g., client machine 510). The API server 514 may send and receive data to and from an application (e.g., programmatic client 508 or third party application 528) running on another client machine (e.g., client machine 512 or third party server 530).

In one embodiment, the merchant marketplace platform 112 provides listings and price-setting mechanisms whereby a user may be a seller or buyer who lists or buys goods and/or services (e.g., for sale) published on the merchant marketplace platform 112. For example, on an electronic storefront.

In one embodiment, the temporary warehouse system 110 includes a system and a method for enabling retailers to setup, ramp up and execute all functions necessary for operating a temporary warehouse.

For example, warehouses or other seller fulfilment centers may include physical facilities located throughout one or more geographic regions configured to hold inventory for sellers. A seller may ship or list for pickup an item sold to a buyer on the merchant marketplace platform 112 from a shipping/pickup location of the seller that is closest to a location designated by or otherwise associated with the buyer. For example, locations associated with a buyer or a seller may be accessed via database server(s) 524 and database(s) 526. If the retailer determines that a spike in local demand makes a temporary warehouse in a nearby location beneficial (e.g., via the temporary warehouse locator 114), then the retailer (e.g., using client machine 512) may enter into an agreement to rent space at a location (near the area of increased demand) that includes an amount of space available for stocking merchandise (e.g., via the temporary warehouse marketplace 116). The retailer may then send to the location, a selection of merchandise that will not require more space to stock than the amount that is available at the location.

Information regarding the location and the amount of space available for stocking merchandise at the location may be received by the temporary warehouse system 110. For example, from a proprietor of the space using client machine 510. Furthermore, the temporary warehouse system 110 may receive, from the retailer via client machine 512 and network 504, details regarding the selection of merchandise, the details including respective amounts for each item of the selection of merchandise. Based on the data regarding the location and the details regarding the selection of merchandise, the temporary warehouse system 110 may interface with an electronic storefront of the retail vendor hosted in the merchant marketplace platform 112 so that the location is displayed on the electronic storefront as a pickup location for the items of the selection.

The temporary warehouse system 110 may, based on the data regarding the location and the details regarding the selection of merchandise, interface with the electronic storefront hosted in the merchant marketplace platform 112 so that the available amount of each item of the selection at the location is displayed on the electronic storefront. Furthermore, based on a customer picking up a purchased item of the selection at the location, the temporary warehouse system 110 may interface with the electronic storefront hosted in the merchant marketplace platform 112 so that the available amount of each item of the selection at the location is updated.

The temporary warehouse system 110 may send sales information regarding the location to an order/inventory management system of the retailer (e.g., a third party application 530 at a third party server 528 or the temporary warehouse marketplace 116) and, based on the sales information, it may be determined (e.g., by the temporary warehouse system 110, by the order/inventory management system of the retailer, by the temporary warehouse marketplace 116, etc.) whether the presence of the retailer's selection of merchandise at the location was a cause of an increase in sales of other items at the location.

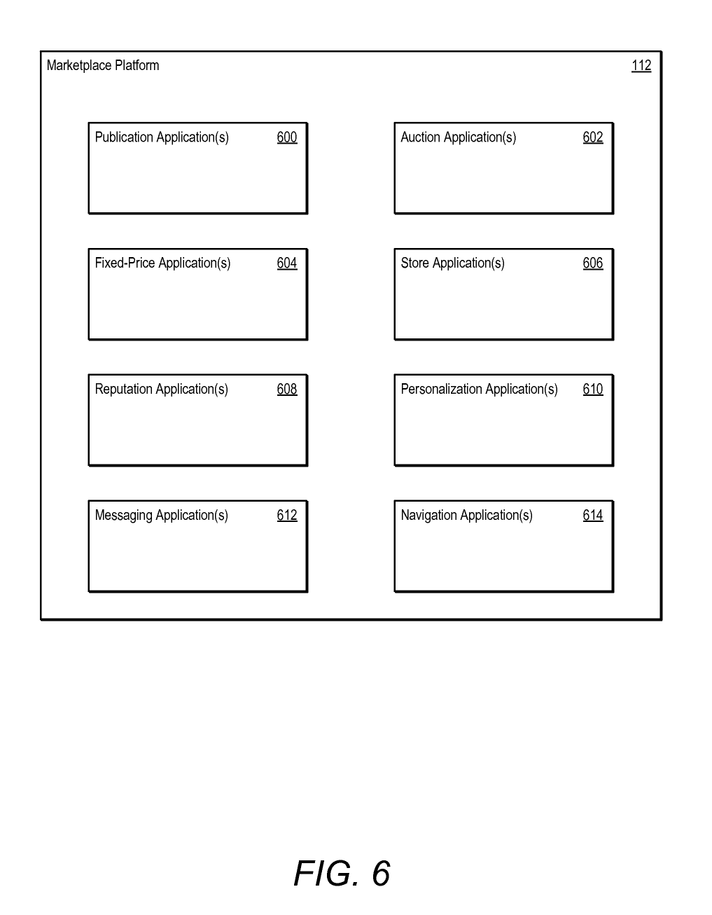

FIG. 6 shows a block diagram illustrating one example embodiment of the merchant marketplace platform 112. The merchant marketplace platform 112 may be hosted on dedicated or shared server machines (not shown) that are communicatively coupled to enable communications between server machines. The merchant marketplace platform 112 and the temporary warehouse system 110 themselves are communicatively coupled (e.g., via appropriate interfaces) to each other and to various data sources, so as to allow information (e.g. regarding a new warehouse setup) to be passed between the merchant marketplace platform 112 and the temporary warehouse system 110 so as to allow the merchant marketplace platform 112 and the temporary warehouse system 110 to share and access common data. The merchant marketplace platform 112 and the temporary warehouse system 110 may, furthermore, access one or more databases 526 via the database servers 524.

The networked system 502 may provide a number of publishing, listing, and price-setting mechanisms whereby a seller (e.g., a retailer) may list goods or services for sale or publish information concerning goods or services for sale; a buyer can express interest in or indicate a desire to purchase such goods or services; and a price can be set for a transaction pertaining to the goods or services. To this end, the merchant marketplace platform 112 is shown to include several applications, for example, at least one publication application 600 and one or more auction applications 602, which support auction-format listing and price setting mechanisms (e.g., English, Dutch, Vickrey, Chinese, Double, Reverse auctions etc.). The various auction applications 602 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 604 support fixed-price listing formats (e.g., the traditional classified advertisement-type listing or a catalogue listing) and buyout-type listings. Specifically, buyout-type listings (e.g., the Buy-It-Now (BIN) technology developed by eBay Inc., of San Jose, California) may be offered in conjunction with auction-format listings, and allow a buyer to purchase goods or services, which are also being offered for sale via an auction, for a fixed-price that is typically higher than the starting price of the auction.

Store applications 606 allow a seller to group listings within a “virtual” store (e.g., electronic storefront), which may be branded and otherwise personalized by and for the seller. Such a virtual store may also offer promotions, incentives, and features that are specific and personalized to a relevant seller.

Reputation applications 608 allow users who transact, utilizing the networked system 502, to establish, build, and maintain reputations, which may be made available and published to potential trading partners. For example, consider that where the networked system 502 supports person-to-person trading, users may have no history or other reference information whereby the trustworthiness and credibility of potential trading partners may be assessed. The reputation applications 608 allow a user (for example, through feedback provided by other transaction partners) to establish a reputation within the networked system 502 over time. Other potential trading partners may then reference such a reputation for the purposes of assessing credibility and trustworthiness.

Personalization applications 610 allow users of the networked system 502 to personalize various aspects of their interactions with the networked system 502. For example a user may, utilizing an appropriate personalization application 610, create a personalized reference page in which information regarding transactions to which the user is (or has been) a party may be viewed. Further, a personalization application 610 may enable a user to personalize listings and other aspects of their interactions with the networked system 502 and other parties.

Messaging applications 612 are responsible for the generation and delivery of messages to users of the networked system 502 (such as, for example, messages advising users regarding the status of listings at the networked system 502 (e.g., providing “outbid” notices to bidders during an auction process or to provide promotional and merchandising information to users)). Respective messaging applications 612 may utilize any one of a number of message delivery networks and platforms to deliver messages to users. For example, messaging applications 612 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Navigation of the networked system 502 may be facilitated by one or more navigation applications 614. For example, a search application (as an example of a navigation application 614) may enable key word searches of listings published via the networked system 502. A browse application may allow users to browse various category, catalogue, or inventory data structures according to which listings may be classified within the networked system 502. Various other navigation applications 614 may be provided to supplement the search and browsing applications.

Furthermore, any one of the applications 600-614 of the marketplace platform 112 may be extended or modified to support any of the temporary warehouse systems 110,114-118 discussed herein. For example, and with reference to FIGS. 3-4, publication application 600 and/or the auction application 602 may be extended or modified so as to support (or provide the functionalities of) the warehouse listing module 312, the warehouse bidding module 314, the recruiter listing module 412, and/or the recruiter bidding module 414. As another example, the messaging application 612 may be extended or modified to support the functions provided by the electronic document module 326 and/or the electronic document module 424. Thus, the marketplace platform 112 may be extensible or modifiable so as to support the functionalities provided by the modules of the temporary warehouse marketplace 116 and/or the temporary warehouse recruiter 118. In this manner, the system discussed herein may be closely integrated so as to provide a cohesive temporary warehouse environment.

FIG. 7 shows a block diagram illustrating one example embodiment of the temporary warehouse system 110. The temporary warehouse system 110 may include a seller module 702, a seller warehouse module 704, a buyer module 706, a seller inventory module 708, an item size and weight module 710, a pickup location determination module 712, an item availability determination module 714, a sales data transmission module 716.

Once an item is sold using the merchant marketplace platform 112, a buyer may select a pickup location from a set of possible pickup locations specified by the seller or associated with the seller's profile. These locations may be determined via the pickup determination module 712. The possible pickup locations may also be based on a location specified by the buyer or associated with the buyer's profile so that the seller locations closest to the location associated with the buyer are included in the set of possible seller pickup locations. The merchant marketplace platform 112 may forward the details of a first purchase transaction between users (e.g. buyer and seller) to the temporary warehouse system 110 to determine if the particular seller has a temporary warehouse that may be closer to an associated buyer location than any of the full time warehouses of the seller such that the temporary warehouse location should be displayed to the buyer as a possible pickup location. Furthermore, the temporary warehouse system 110 may keep track of the inventory of items in a network of seller warehouses with the seller inventory module 708. Additional data may be mined by the temporary warehouse system 110 from the historical data of the merchant marketplace platform 112 to determine, for example, item details like descriptions, dimensions, weights, frequency of sales received for a geographic region and estimated delivery costs. This data may be stored and/or accessed via database server(s) 124 and databases(s) 126 and used by the merchant marketplace platform 112 to, for example, determine the compatibility of a potential warehouse space and a retailer's selection of inventory items.

Warehouses or seller warehouses may include physical facilities located throughout one or more geographic regions configured to hold inventory for sellers so that a seller may list at least the one of these warehouses that is closest to a buyer location as a possible pickup location for items purchased by said buyer.

The seller module 702 may identify at least one pickup location (e.g., warehouse) associated with the seller or other relevant data associated with the seller, e.g. seller profile. For example, the location may be a residence location of the seller, work location of the seller, or any other location specified by the seller where the item may be picked up from by the seller. The seller may include a user who listed an item for sale using the merchant marketplace platform 112. The term “seller” may also refer to a user who has sold or not yet sold a listed item for sale in the merchant marketplace platform 112. The seller module 702 may communicate with the merchant marketplace platform 112 to access location information of the seller although this data may also be stored and/or accessed via database server(s) 525 and databases(s) 526. Alternatively or additionally, the seller module 702 may communicate with the temporary warehouse marketplace 116 to obtain this information.

The seller warehouse module 704 identifies any warehouses (or other designated pick-up locations) associated with a seller identified by the seller module 702. The region serviced by a warehouse may include a geographic region such as a zip code area, a county, a city, etc. In one embodiment, the seller warehouse module 704 identifies one or more warehouses from a network of warehouses known to the merchant marketplace platform 112 and/or the temporary warehouse marketplace 116. The seller warehouse module 704 may communicate with the merchant marketplace platform 112 and/or the temporary warehouse marketplace 116 to access warehouse location information of the seller although this data may also be stored and/or accessed via database server(s) 524 and databases(s) 526. The seller warehouse module 704 may also access data regarding any temporary warehouses setup by a particular seller such that the locations and capacities of these temporary facilities are also known. The seller warehouse module 704 may also identify the capacities of the warehouses. Capacities may include physical space, available space, strategic geographic area, manpower, ease of access to shipping carriers, etc.

The buyer module 706 identifies a location associated with the buyer or other relevant data associated with the buyer, e.g. buyer profile. The location may include the drop-off location where the buyer would like the item delivered. For example, the buyer may identify several locations in the merchant marketplace platform 112 for drop-off locations (e.g., home, work, vacation home, etc.). The buyer may also identify a default drop-off location. The buyer may include a user who views an item for sale using the merchant marketplace platform 112. The term “buyer” may refer to a user who has, for example, viewed items for sale without making a purchase, placed any item for sale in a virtual shopping cart or wish list, or purchased any item for sale. The buyer module 706 may communicate with the merchant marketplace platform 112 and/or the temporary warehouse marketplace 116 to access location information of the buyer although this data may also be stored and/or accessed via database server(s) 524 and databases(s) 526.

The seller inventory module 708 may identify the inventory of items in each warehouse of a network of seller warehouses. For example, the seller inventory module 708 may identify one or more seller warehouses that stock a purchased item so that this information may be cross-referenced with the warehouse location information, e.g., provided by the seller warehouse module 704. This data may be stored and/or accessed via database server(s) 124 and databases(s) 126.

The item size and weight module 710 identifies physical dimensions of the item listed for sale by the seller by accessing historical data of the merchant marketplace platform 112. This data may also be stored and/or accessed via database server(s) 124 and databases(s) 126. For example, the item size and weight module 710 can determine how big and how heavy an item is based on an identification of the item and the historical data. In another example, the seller may provide dimensions and weight of the item. In another embodiment, the item size and weight module 710 identifies physical dimensions of a package containing the item listed for sale by the seller using historical data of the merchant marketplace platform 112. For example, the item size and weight module 710 may determine or estimate common or typical physical dimensions of a package used to ship the item based on an identification of the item and the historical data. The item size and weight module 710 may provide information to be cross-referenced with the warehouse capacity information provided by the seller warehouse module 704 to determine if a seller warehouse may stock a particular item or how many of the items may be stocked.

The pickup location determination module 712 may access information regarding associated buyer, seller and warehouse locations provided by the respective identification modules (702, 704 and 706) and the inventory information provided by seller inventory module 708 to determine which of the seller warehouse locations (including any temporary warehouse locations) should be displayed to a buyer as possible pickup locations for a purchased item. For example, a seller may list an item for sale on an electronic storefront of the merchant marketplace platform 112 and display, together with the item listing, various possible pickup locations (e.g., warehouses) of the seller that are closest to a location designated by or otherwise associated with the buyer. For example, locations associated with a buyer or a seller may be accessed via database server(s) 124 and database(s) 126. For example, a seller may have setup a temporary warehouse to satisfy a spike in local demand by entering into an agreement to rent space at a location (near the area of increased demand) that includes an amount of space available for stocking merchandise and sending a selection of merchandise to the location. The location may be displayed as a possible user selected pick-up location for an item as determined by the pickup location determination module.

In an example, information regarding the location and the amount of space available for stocking merchandise at the location may be received by the temporary warehouse system 110 and accessed by the seller warehouse module. For example, the information may be received from a proprietor of the space or from a seller renting the space. Based on the data regarding the location and the details regarding the selection of merchandise, the temporary warehouse system 110 (via pickup location determination module 712) may interface with an electronic storefront of the retail vendor hosted in the merchant marketplace platform 112 so that the location is displayed on the electronic storefront as a possible pickup location for the items of the selection.

In an example, the temporary warehouse system 110 (via item availability determination module 714) may, based on the data regarding the location and the details regarding the selection of merchandise, interface with the electronic storefront hosted in the merchant marketplace platform 112 so that the available amount of each item of the selection at the location is displayed on the electronic storefront.

In an example, based on a buyer picking up a purchased item of the selection at the location, the temporary warehouse system 110 (via item availability determination module 714) may interface with the electronic storefront hosted in the merchant marketplace platform 112 so that the available amount of each item of the selection at the location is updated.

In an example, the temporary warehouse system 110 (via a sales transmission module 716) may send sales information regarding the location to an order/inventory management system of a seller so that, based on the sales information, the seller may determine whether the presence of the seller's selection of merchandise at the location was a cause of an increase in sales of other items at the location.

In an example, once an order is placed, a seller warehouse selected (from a displayed list of possible pickup locations) as a pickup location by a buyer may receive a notification of the selection; and the buyer may receive a notification that a purchased item is ready for pick-up.

In an example, when the buyer arrives at the warehouse (e.g., a school acting as a temporary warehouse) a warehouse employee may scan the order confirmation email, check the buyer's ID and hand over the item. The picked up scan operation may be accomplished, for example, via a mobile device that sends a notification to the seller's inventory/order management system to decrement the available quantity of the sold item.

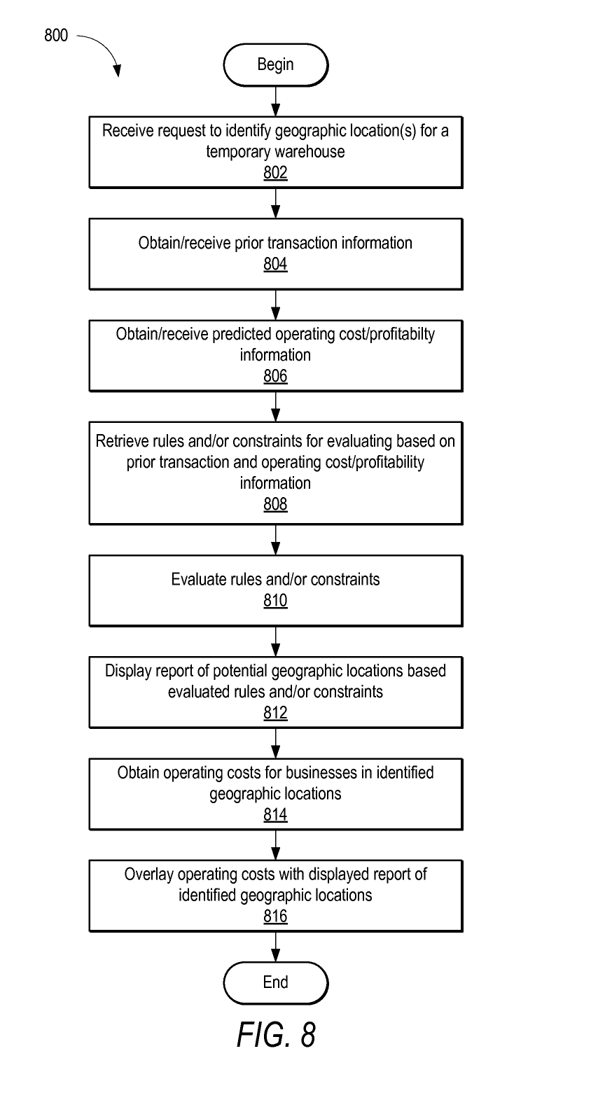

FIG. 8 shows a flow diagram illustrating one example embodiment of a method 800 for identifying geographic locations for a temporary warehouse. The method 800 may be implemented by the temporary warehouse locator 114 and, accordingly, is merely described by reference thereto. At operation 802, the temporary warehouse locator 114 may receive one or more requests to identify one or more geographic locations for one or more temporary warehouses. At operation 804, the temporary warehouse locator 114 may then obtain and/or receive prior transaction information from the retailer associated with the requests, such as by obtaining and/or receiving this information from the retailer inventory system 108 or the marketplace platform 112. At operation 806, the temporary warehouse locator 114 may then receive and/or obtain operating cost and/or profitability information from the retailer associated with the requests. For example, and as discussed with reference to FIG. 2, the retailer access module 218 may access a retailer inventory system 108 to obtain this information or the user interface 212 may request this information from the retailer. At operation 808, the temporary warehouse locator 114 then retrieves one or more rules and/or constraints for evaluating with the received transaction and/or operating cost information. For example, the rules engine 214 may retrieve one or more rules and/or constraints from the rules and/or constraint data 230. In addition, the retrieved one or more rules and/constraints may be based on the retailer information obtained or provided to the temporary warehouse locator 116.

At operation 810, the temporary warehouse locator 114 evaluates the retrieved rules and/or constraints (e.g., via the rules engine 214) and, at operation 812, displays a report identifying geographic locations for one or more temporary warehouses based upon the evaluated rules and/or constraints. As discussed previously, the report may include a gradient heatmap or other graphical report indicating different levels of desirability for one or more geographic locations where the retailer could establish a temporary warehouse. Thereafter, at operation 814, the temporary warehouse locator 114 may obtain operating costs for businesses in or near the identified geographic locations. At operation 816, the temporary warehouse locator 114 may then overlay such operating costs on the report identifying the geographic locations for the one or more temporary warehouses. As one example, the overlaid operating costs for nearby businesses may be semi-transparent (e.g., via an alpha channel) such that the gradient heatmap is visible underneath the overlaid operating costs. The overlay of the operating costs provides an understanding to the retailer of the potential costs involved in operating a temporary warehouse at a given geographic location, and guides the retailer into making an informed decision as to the more (or most) profitable geographic location to establish a temporary warehouse.

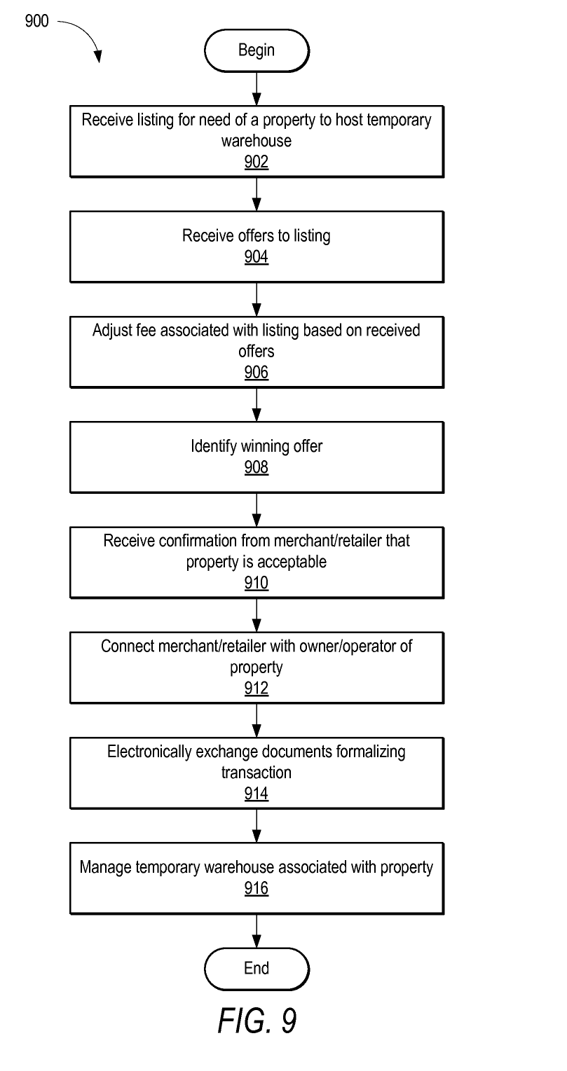

FIG. 9 shows a flow diagram illustrating one example embodiment of a method 900 for connecting a merchant with a need for a property to host a temporary warehouse with an owner/operator of such a property. The method 900 may be implemented by the temporary warehouse marketplace 116 and, accordingly, is merely described by reference thereto. At operation 902, the temporary warehouse marketplace 116 may receive a listing to publish, where the listing identifies a need for a property to host a temporary warehouse. The listing may be received from a merchant/retailer that previously used the temporary warehouse locator 114 to identify potential geographic locations for the temporary warehouse. As discussed previously, the listing may include an amount of space needed, a preferred industry type, the geographic locations (e.g., at or within a predetermined distance thereto) for locating the temporary warehouse, and other such characteristics. The listing may also identify whether the retailer is willing to consider using a portion of a property (e.g., 2500 sq. ft. of a 5000 sq. ft. warehouse).

At operation 904, the temporary warehouse marketplace 116 may then obtain and/or receive offers (e.g., bids) from owner/operators of property in or near (e.g., within a predetermined distance) the identified geographic locations. At operation 906, the temporary warehouse marketplace 116 may adjust a fee associated with listing based on the number of bids received (e.g., the fee may increase or decrease each time a bid is submitted or after a predetermined number of bids are submitted). At operation 908, the temporary warehouse marketplace 116 may then identify a winning bid, such as a bid that meets or exceeds the fee after a predetermined time period has elapsed. The temporary warehouse marketplace 116 may also inform the merchant/retailer of the winning bid so that the merchant/retailer has an opportunity to review the characteristics of the property to confirm that the property would satisfy the requirements of the temporary warehouse.

At operation 910, the temporary warehouse marketplace 116 may receive a confirmation from the merchant/retailer that the property associated with the winning bid is acceptable. At operation 912, the temporary warehouse marketplace 116 may then connect the merchant/retailer with the need for the property with the owner/operator of such property. For example, and as discussed previously, the temporary warehouse marketplace may leverage a messaging module 324 to initiate communications between the parties. At operation 914, the parties may then electronically exchange documents for execution (e.g., a digital signature), such as a leasing or sub-leasing agreement, via an electronic document management module 326. After the transaction is completed and the various documents are signed, the merchant/retailer may then manage the temporary warehouse. As also discussed previously, the merchant/retailer may manage the temporary warehouse via a warehouse management module 316, which facilitates electronic monitoring and tracking of the various activities occurring at the temporary warehouse (e.g., shipping, packaging, inventory levels, supply levels, duration of operations, etc.). Accordingly, at operation 916, the merchant/retailer may manage the temporary warehouse using the temporary warehouse marketplace 116.

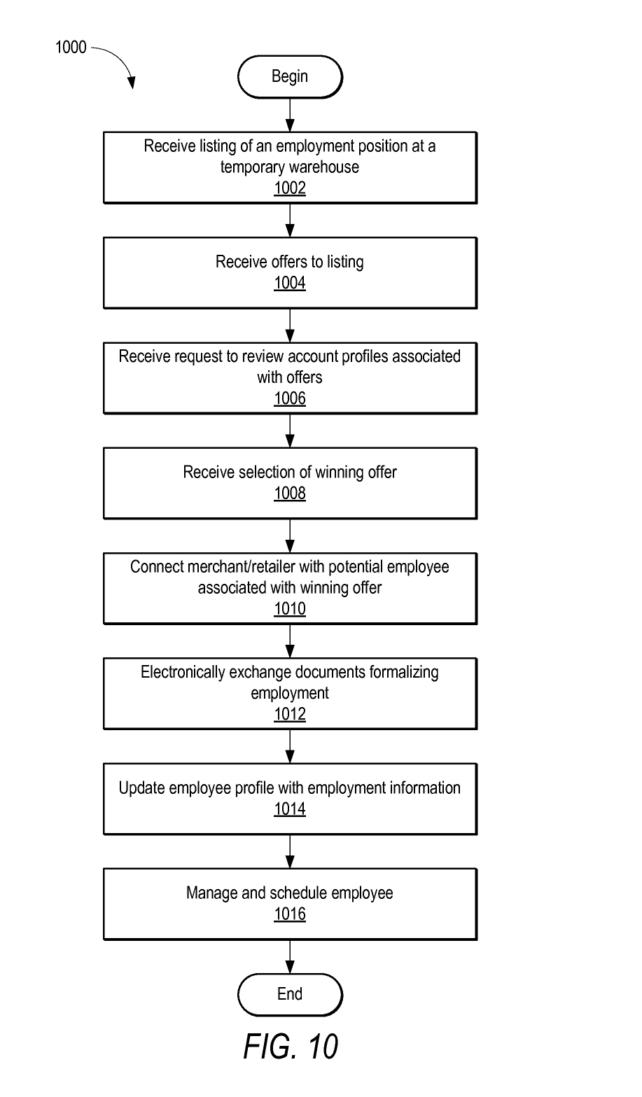

FIG. 10 shows a flow diagram illustrating one example embodiment of a method 1000 for connecting a merchant with a need for a workforce to operate a temporary warehouse with potential employees. The method 1000 may be implemented by the temporary warehouse recruiter 118 and, accordingly, is merely described by reference thereto. At operation 1002, the temporary warehouse recruiter 118 may receive a listing to publish, where the listing identifies an employment position with a temporary warehouse. The listing may be received from a merchant/retailer that previously used the temporary warehouse marketplace 116 to establish and set up the temporary warehouse.

At operation 1004, the temporary warehouse recruiter 118 may then obtain and/or receive offers (e.g., bids) from potential employees in or near (e.g., within a predetermined distance) of the temporary warehouse. At operation 1006, the temporary warehouse recruiter 118 may receive requests from the merchant/retailer to review account information associated with the potential employees of the received offers, where the account information may include rating information, past work experience, feedback from prior employers, and other such information. Alternatively or additionally, the temporary warehouse recruiter 118 may adjust a fee associated with the listing, such as by increasing or decreasing the fee.

At operation 1008, the temporary warehouse recruiter may receive a selection from the merchant/retailer of a winning offer (e.g., an offer associated with a potential employee having qualifications that the merchant/retailer finds desirable). At operation 1010, the temporary warehouse recruiter 118 may then connect the merchant/retailer with the potential employee associated with the winning offer. Accordingly, at operation 1012, the temporary warehouse recruiter 118 may facilitate the exchange of electronic documents to formalize the employment of the employee by the merchant/retailer.

At operation 1014, the temporary warehouse recruiter 118 may update the user profile to indicate that the user is employed by the merchant/retailer. At operation 1016, the merchant/retailer may then manage and/or schedule the employee for work at the temporary warehouse via the temporary warehouse recruiter 118.

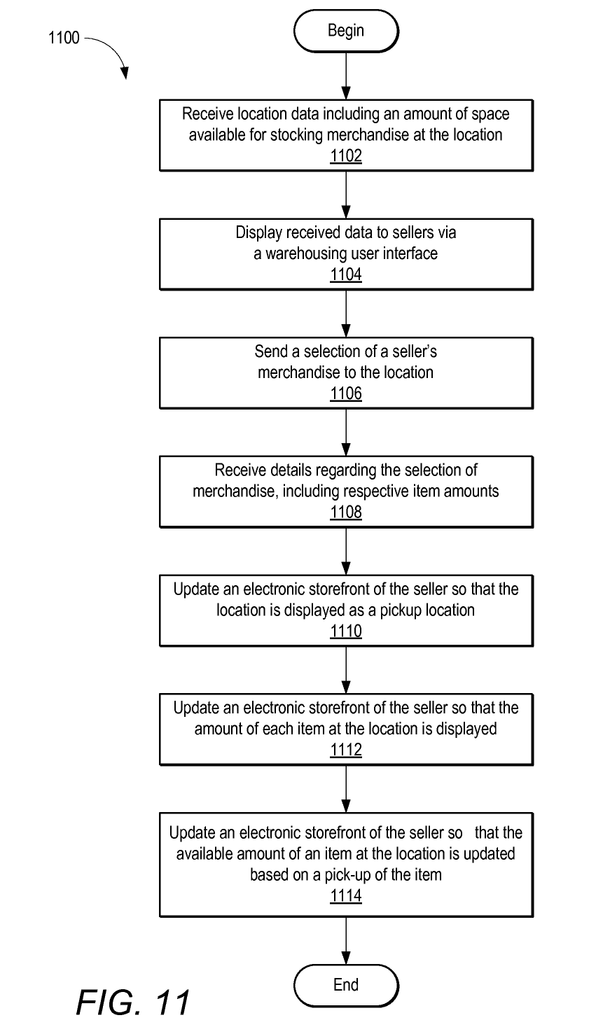

FIG. 11 shows a flow diagram illustrating one example embodiment of a method 1100 for setting up and managing a temporary warehouse.

At operation 1102, data is received regarding a location and an amount of space available for stocking merchandise at the location and this data is displayed to retailers via a temporary warehouse user interface.

At operation 1104, the received data regarding the location and the amount of available space are displayed to sellers (e.g., retailers) via the temporary warehouse user interface.

At operation 1106, a retail vendor may send a selection of merchandise to the location, wherein the selection of merchandise does not require more space to stock than the amount that is available at the location.

At operation 1108, details regarding the selection of merchandise are received, the details including respective amounts for each item of the selection of merchandise.

At operation 1110, based on the data regarding the location and the details regarding the selection of merchandise, an electronic storefront of the retail vendor is updated so that the location is displayed on the electronic storefront as a pickup location for the items of the selection.

At operation 1112, based on the data regarding the location and the details regarding the selection of merchandise, an electronic storefront of the retail vendor is updated so that the available amount of each item of the selection at the location is displayed on the electronic storefront.

At operation 1114, based on a customer picking up a purchased item of the selection at the location, updating the electronic storefront so that the available amount of each item of the selection at the location is updated to be accurate.

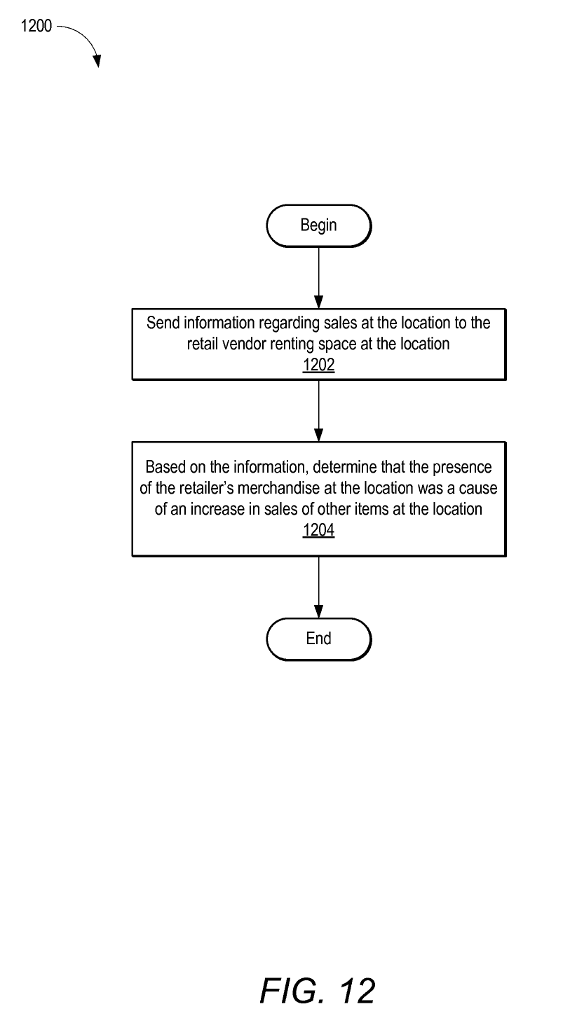

FIG. 12 shows a flow diagram illustrating one example embodiment of a method 1200 for analyzing the effect of the seller's merchandise on sales at a temporary warehouse location.

At operation 1202, information regarding sales at the temporary warehouse location is sent to a retail vendor stocking inventory at the location.

At operation 1204, the retail vendor may determine (based on the sales information) that the presence of the retailer's selection of merchandise at the temporary warehouse location was a cause of an increase in sales of other items at the location.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via network 504 (e.g., the Internet) and via one or more appropriate interfaces (e.g., APIs).

Example embodiments may be implemented in digital electronic circuitry, or in computer hardware, firmware, software, or in combinations of them. Example embodiments may be implemented using a computer program product, (e.g., a computer program tangibly embodied in an information carrier, e.g., in a machine-readable medium for execution by, or to control the operation of, data processing apparatus, e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Below are set out hardware (e.g., machine) and software architectures that may be deployed in various example embodiments.

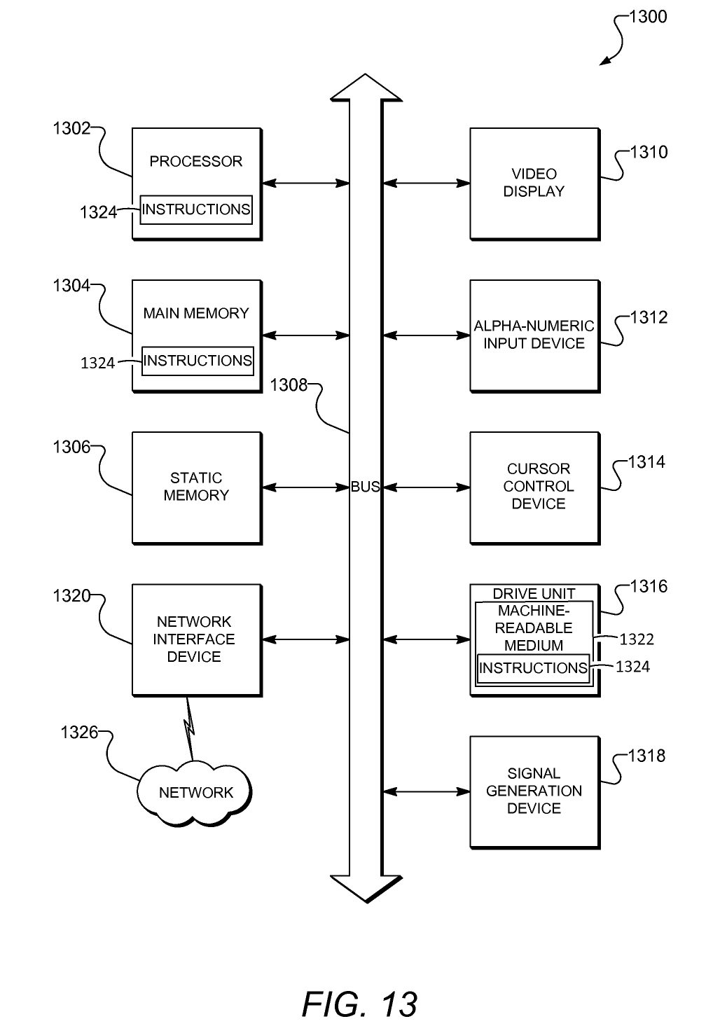

FIG. 13 shows a diagrammatic representation of a machine in the example form of a computer system 1300 within which a set of instructions 1324 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine 110 or 112 in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions 1324 (sequential or otherwise) that specify actions to be taken by that machine. Further, while only a single machine is illustrated, the term “machine” shall also be taken to include any collection of machines that individually or jointly execute a set (or multiple sets) of instructions 1324 to perform any one or more of the methodologies discussed herein.

The example computer system 1300 includes a processor 1302 (e.g., a central processing unit (CPU), a graphics processing unit (GPU, or both)), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a UI navigation device 1314 (e.g., a mouse), a disk drive unit 1316, a signal generation device 1318 (e.g., a speaker), and a network interface device 1320.

The disk drive unit 1316 includes a computer-readable medium 1322 on which is stored one or more sets of data structures and instructions 1324 (e.g., software) embodying or utilized by any one or more of the methodologies or functions described herein. The instructions 1324 may also reside, completely or at least partially, within the main memory 1304 and/or within the processor 1302 during execution thereof by the computer system 1300, with the main memory 1304 and the processor 1302 also constituting machine-readable media.

The instructions 1324 may further be transmitted or received over a network 1326 via the network interface device 1320 utilizing any one of a number of well-known transfer protocols (e.g., HTTP).

While the computer-readable medium 1322 is shown in an example embodiment to be a single medium, the term “computer-readable medium” should be taken to include a single medium or multiple media (e.g., a centralized or distributed database, and/or associated caches and servers) that store the one or more sets of instructions 1324. The term “computer-readable medium” shall also be taken to include any medium that is capable of storing, encoding, or carrying a set of instructions 1324 for execution by the machine and that cause the machine to perform any one or more of the methodologies of the present disclosure, or that is capable of storing, encoding or carrying data structures utilized by or associated with such a set of instructions 1324. The term “computer-readable medium” shall, accordingly, be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method comprising:
receiving, with one or more processors, a request to identify one or more geographic locations for a temporary warehouse;
obtaining, with the one or more processors, transaction information associated with a plurality of transactions conducted by an organization;
determining the one or more geographic locations for the temporary warehouse based on the obtained transaction information and the obtained shipping information;
displaying a first display that includes the determined one or more geographic locations for the temporary warehouse, the first display indicating a degree of desirability for at least one of the one or more geographic locations; and
displaying a second display with the first display, the second display indicating operational information for the temporary warehouse for the at least one of the determined one or more geographic locations.

2. The method of claim 1, further comprising applying a mapping to the obtained transaction information, the mapping translating a first plurality of data fields of the transaction information to a second plurality of data fields, where at least one of the second plurality of data fields is used in determining the one or more geographic locations for the temporary warehouse.

3. The method of claim 1, wherein determining the one or more geographic locations for the temporary warehouse is further based on a plurality of geographic locations where the organization has a preexisting presence.

4. The method of claim 1, further comprising:
after displaying the first display, receiving a change to the transaction information; and
updating the first display to indicate a change in the degree of desirability for the at least one of the one or more geographic locations.

5. The method of claim 1, wherein the operational information for the temporary warehouse is based on an operating cost associated with the at least one of the determined one or more geographic locations.

6. The method of claim 5, further comprising:
receiving an acceptable operating cost for operating the temporary warehouse; and
updating the second display to show a change in the operational information based on the received acceptable operating cost.

7. The method of claim 1, wherein the transaction information is represented as a plurality of constraints; and
determining the one or more geographic locations for the temporary warehouse is performed through constraint-based linear optimization with the plurality of constraints.

8. A system comprising:
a non-transitory, computer-readable medium storing computer-executable instructions; and
one or more processors in communication with the non-transitory, computer-readable medium that, having executed the computer-executable instructions, are configured to:
receive a request to identify one or more geographic locations for a temporary warehouse;
obtain transaction information associated with a plurality of transactions conducted by an organization;
determine the one or more geographic locations for the temporary warehouse based on the obtained transaction information and the obtained shipping information;
display a first display that includes the determined one or more geographic locations for the temporary warehouse, the first display indicating a degree of desirability for at least one of the one or more geographic locations; and
display a second display with the first display, the second display indicating operational information for the temporary warehouse for the at least one of the determined one or more geographic locations.

9. The system of claim 8, wherein the one or more processors are further configured to apply a mapping to the obtained transaction information, the mapping translating a first plurality of data fields of the transaction information to a second plurality of data fields, where at least one of the second plurality of data fields is used in determining the one or more geographic locations for the temporary warehouse.

10. The system of claim 8, wherein the one or more processors are further configured to determine the one or more geographic locations for the temporary warehouse based on a plurality of geographic locations where the organization has a preexisting presence.

11. The system of claim 8, wherein the one or more processors are further configured to:
receive a change to the transaction information after displaying the first display; and
update the first display to indicate a change in the degree of desirability for the at least one of the one or more geographic locations.

12. The system of claim 8, wherein the operational information for the temporary warehouse is based on an operating cost associated with the at least one of the determined one or more geographic locations.

13. The system of claim 12, wherein the one or more processors are further configured to:
receive an acceptable operating cost for operating the temporary warehouse; and
update the second display to show a change in the operational information based on the received acceptable operating cost.

14. The system of claim 8, wherein the transaction information is represented as a plurality of constraints; and
the one or more processors are further configured to determine the one or more geographic locations for the temporary warehouse through constraint-based linear optimization with the plurality of constraints.

15. A non-transitory, computer-readable medium storing computer-executable instructions thereon that, when executed by one or more processors, cause the one or more processors to perform a method, the method comprising:
receiving, with one or more processors, a request to identify one or more geographic locations for a temporary warehouse;
obtaining, with the one or more processors, transaction information associated with a plurality of transactions conducted by an organization;
determining the one or more geographic locations for the temporary warehouse based on the obtained transaction information and the obtained shipping information;
displaying a first display that includes the determined one or more geographic locations for the temporary warehouse, the first display indicating a degree of desirability for at least one of the one or more geographic locations; and
displaying a second display with the first display, the second display indicating operational information for the temporary warehouse for the at least one of the determined one or more geographic locations.

16. The non-transitory, computer-readable medium of claim 15, wherein the method further comprises applying a mapping to the obtained transaction information, the mapping translating a first plurality of data fields of the transaction information to a second plurality of data fields, where at least one of the second plurality of data fields is used in determining the one or more geographic locations for the temporary warehouse.

17. The non-transitory, computer-readable medium of claim 15, wherein determining the one or more geographic locations for the temporary warehouse is further based on a plurality of geographic locations where the organization has a preexisting presence.

18. The non-transitory, computer-readable medium of claim 15, wherein the method further comprises:
receiving a change to the transaction information after displaying the first display; and
updating the first display to indicate a change in the degree of desirability for the at least one of the one or more geographic locations.

19. The non-transitory, computer-readable medium of claim 15, wherein the operational information for the temporary warehouse is based on an operating cost associated with the at least one of the determined one or more geographic locations.

20. The non-transitory, computer-readable medium of claim 19, wherein the method further comprises:
receiving an acceptable operating cost for operating the temporary warehouse; and
updating the second display to show a change in the operational information based on the received acceptable operating cost.
